(19) United States
(12) Patent Application Publication
(10) Pub. No.: US 2024/0080695 A1
(43) Pub. Date: Mar. 7, 2024

(54) User Equipment Reporting of Reconnection after Link Failure

(71) Applicant: Telefonaktiebolaget LM Ericsson (publ), Stockholm (SE)

(72) Inventors: Pradeepa Ramachandra, Linköping (SE); Marco Belleschi, Solna (SE)

(21) Appl. No.: 18/262,524

(22) PCT Filed: Mar. 18, 2022
(86) PCT No.: PCT/SE2022/050260

§ 371 Date: Jul. 21, 2023

Related U.S. Application Data
(60) Provisional application No. 63/168,411, filed on Mar. 31, 2021.

(51) Int. Cl. H04W 24/10; H04W 36/30

(52) U.S. Cl. CPC H04W 24/10; H04W 36/305; H04W 84/042

(57) ABSTRACT

Embodiments include methods for a user equipment (UE) to report link failures in a wireless network. Such methods include, after a link failure (e.g., radio link failure or handover failure) and a failed connection reestablishment in a first public land mobile network (PLMN), connecting to a first cell in the wireless network. Such methods include sending, to a radio network node (RNN) in the wireless network, a failure report including an indication of whether the first cell is associated with the first PLMN. Different forms and/or contents of the indication are disclosed. Other embodiments include complementary methods for a RNN, as well as UEs and RNNs configured to perform such methods.

### TECHNICAL FIELD

The present disclosure relates generally to wireless communication networks and more specifically to improved techniques for reporting of link failures (e.g., radio link failures, handover failures, etc.) experienced by user equipment (UEs) in such networks.

### BACKGROUND

Long-Term Evolution (LTE) is an umbrella term for so-called fourth-generation (4G) radio access technologies developed within the Third-Generation Partnership Project (3GPP) and initially standardized in Release 8 (Rel-8) and Release 9 (Rel-9), also known as Evolved UTRAN

(E-UTRAN). LTE is targeted at various licensed frequency bands and is accompanied by improvements to non-radio aspects commonly referred to as System Architecture Evolution (SAE), which includes Evolved Packet Core (EPC) network. LTE continues to evolve through subsequent releases.

An overall exemplary architecture of a network comprising LTE and SAE is shown in FIG. 1. E-UTRAN 100 includes one or more evolved Node B's (eNB), such as eNBs 105, 110, and 115, and one or more user equipment (UE), such as UE 120. As used within the 3GPP standards, “user equipment” or “UE” means any wireless communication device (e.g., smartphone or computing device) that can communicate with 3GPP-standard-compliant network equipment, including E-UTRAN as well as UTRAN and/or GERAN, as the third-generation (“3G”) and second-generation (“2G”) 3GPP RANs are commonly known.

As specified by 3GPP, E-UTRAN 100 is responsible for all radio-related functions in the network, including radio bearer control, radio admission control, radio mobility control, scheduling, and dynamic allocation of resources to UEs in uplink and downlink, as well as security of the communications with the UE. These functions reside in the eNBs, such as eNBs 105, 110, and 115. Each of the eNBs can serve a geographic coverage area including one more cells, including cells 106, 111, and 115 served by eNBs 105, 110, and 115, respectively.

The eNBs in the E-UTRAN communicate with each other via the X2 interface, as shown in FIG. 1. The eNBs also are responsible for the E-UTRAN interface to the EPC 130, specifically the S1 interface to the Mobility Management Entity (MME) and the Serving Gateway (SGW), shown collectively as MME/S-GWs 134 and 138 in FIG. 1. In general, the MME/S-GW handles both the overall control of the UE and data flow between the UE and the rest of the EPC. More specifically, the MME processes the signaling (e.g., control plane) protocols between the UE and the EPC, which are known as the Non-Access Stratum (NAS) protocols. The S-GW handles all Internet Protocol (IP) data packets (e.g., data or user plane) between the UE and the EPC and serves as the local mobility anchor for the data bearers when the UE moves between eNBs, such as eNBs 105, 110, and 115.

EPC 130 can also include a Home Subscriber Server (HSS) 131, which manages user- and subscriber-related information. HSS 131 can also provide support functions in mobility management, call and session setup, user authentication and access authorization. The functions of HSS 131 can be related to the functions of legacy Home Location Register (HLR) and Authentication Centre (AuC) functions or operations. HSS 131 can also communicate with MMES 134 and 138 via respective S6a interfaces.

In some embodiments, HSS 131 can communicate with a user data repository (UDR)—labelled EPC-UDR 135 in FIG. 1—via a Ud interface. EPC-UDR 135 can store user credentials after they have been encrypted by AuC algorithms. These algorithms are not standardized (i.e., vendor-specific), such that encrypted credentials stored in EPC-UDR 135 are inaccessible by any other vendor than the vendor of HSS 131.

FIG. 2 illustrates a block diagram of an exemplary control plane (CP) protocol stack between a UE, an eNB, and an MME. The exemplary protocol stack includes Physical (PHY), Medium Access Control (MAC), Radio Link Control (RLC), Packet Data Convergence Protocol (PDCP), and Radio Resource Control (RRC) layers between the UE and eNB. The PHY layer is concerned with how and what characteristics are used to transfer data over transport channels on the LTE radio interface. The MAC layer provides data transfer services on logical channels, maps logical channels to PHY transport channels, and reallocates PHY resources to support these services. The RLC layer provides error detection and/or correction, concatenation, segmentation, and reassembly, reordering of data transferred to or from the upper layers. The PDCP layer provides ciphering/deciphering and integrity protection for both CP and user plane (UP), as well as other UP functions such as header compression. The exemplary protocol stack also includes NAS signaling between the UE and the MME.

The RRC layer controls communications between a UE and an eNB at the radio interface, as well as the mobility of a UE between cells in the E-UTRAN. After a UE is powered. ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE does not belong to any cell, no RRC context has been established for the UE (e.g., in E-UTRAN), and the UE is out of UL synchronization with the network. Even so, a UE in RRC_IDLE state is known in the EPC and has an assigned IP address.

Furthermore, in RRC_IDLE state, the UE's radio is active on a discontinuous reception (DRX) schedule configured by upper layers. During DRX active periods (also referred to as “On durations”), an RRC_IDLE TIE receives system information (SI) broadcast by a serving cell, performs measurements of neighbor cells to support cell reselection, and monitors a paging channel for pages from the EPC via an eNB serving the cell in which the LE is camping.

A UE must perform a random-access (RA) procedure to move from RRC_IDLE to RRC_CONNECTED state. In RRC_CONNECTED state, the cell serving the UE is known and an RRC context is established for the UE in the serving eNB, such that the UE and eNB can communicate. For example, a Cell Radio Network Temporary Identifier (C-RNTI)—a UE identity used for signaling between UE and network—is configured for a UE in RRC_CONNECTED state.

The fifth generation (“5G”) of cellular systems, also referred to as New Radio (NR), is being standardized within the Third-Generation Partnership Project (3GPP). NR is developed for maximum flexibility to support a variety of different use cases. These include enhanced mobile broadband (eMBB), machine type communications (MTC), ultra-reliable low latency communications (URLLC), and several other use cases.

5G/NR technology shares many similarities with fourth-generation LTE. For example, NR RRC layer includes RRC_IDLE and RRC_CONNECTED states, but adds another state known as RRC_INACTIVE. In addition to providing coverage via “cells,” as in LTE, NR networks also provide coverage via “beams.” In general, a DL “beam” is a coverage area of a network-transmitted reference signal (RS) that may be measured or monitored by a UE.

A common mobility procedure for UEs in RRC_CONNECTED state is handover (HO) between cells. A UE is handed over from a source or serving cell, provided by a source node, to a target cell provided by a target node. In general, for LTE (or NR), handover source and target nodes are different eNBs (or gNBs), although intra-node handover between different cells provided by a single eNB (or gNB) is also possible. Successful handovers enable the UE moves around in the network coverage area without excessive interruptions in data transmission.

### SUMMARY

Even so, handover and other mobility procedures can have various problems related to robustness. Failure of handover to a target cell may lead to the UE declaring radio link failure (RLF) in the source cell. A UE logs relevant information at time of RLF and later reports this information to the network via a target cell to which the UE ultimately connects (e.g., after reestablishment). The reported information can include RRM measurements of various neighbor cells prior to the mobility operation (e.g., handover). In particular, the UE can indicate that it has an RLF report and then send the RLF report upon network request (e.g., by the node serving the UE's new serving cell). However, there are various problems, issues, and/or difficulties for RLF reporting when a UE ultimately connects to a cell in a second network (e.g., LTE) after declaring RLF in a cell in a first network (e.g., NR).

Embodiments of the present disclosure provide specific improvements to failure reporting in a wireless network, such as by facilitating solutions to overcome exemplary problems summarized above and described in more detail below.

Embodiments of the present disclosure include methods (e.g., procedures) for a UE to report link failures in a wireless network. These exemplary methods can include, after a link failure and a failed connection reestablishment in a first PLMN, connecting to a first cell in the wireless network. These exemplary methods can also include sending, to a radio network node (RNN) in the wireless network, a failure report including an indication of whether the first cell is associated with the first PLMN.

In some embodiments, the link failure is an RLF or a handover failure (HOF) declared by the UE in the first PLMN, and the failure report is an RLF report. In some embodiments, the link failure occurred in a second cell associated with the first PLMN and the failed connection reestablishment occurred in a third cell associated with the first PLMN.

In some embodiments, these exemplary methods can also include, in response to the link failure, storing a list of PLMN identifiers associated with a cell in which the link failure occurred, including an identifier of the first PLMN. In some of these embodiments, the list of PLMN identifiers is included in the failure report. In some of these embodiments, the RNN is part of at least one of the PLMNs identified in the list.

In some of these embodiments, these exemplary methods can also include determining whether the first cell is associated with any of the PLMN identifiers in the list. The indication can be based on the outcome of this determination, according to different variants discussed below.

In some variants, the indication comprises:
an identifier of the first cell, when the first cell is associated with at least one PLMN identifier included in the list; and
no identifier of the first cell, when the first cell is not associated with any of the PLMN identifiers included in the list.

In other variants, the indication comprises:
an identifier of the first cell, and
when the first cell is not associated with any of the PLMN identifiers included in the list, an indication that the UE first reconnected to the wireless network, after the link failure and the failed connection reestablishment, in a PLMN that is not identified in the list.

In other variants, the indication comprises:
when the first cell is associated with at least one PLMN identifier included in the list, an identifier of the first cell and a further indication of time elapsed between the link failure and connecting to the first cell; and
when the first cell is not associated with any of the PLMN identifiers included in the list, an indication that the UE first reconnected to the wireless network, after the link failure and the failed connection reestablishment, in a PLMN that is not identified in the list.

In other variants, the indication comprises:
a further indication of a time elapsed between the link failure and connecting to the first cell; and
when the first cell is not associated with any of the PLMN identifiers included in the list, an indication that the UE first reconnected to the wireless network, after the link failure and the failed connection reestablishment, in a PLMN that is not identified in the list.

Other embodiments include methods (e.g., procedures) for an RNN in a wireless network to receive failure reports from UEs. These exemplary methods can include receiving, from a UE, a failure report including an indication of whether a first cell, to which the UE connected after a link failure and after a failed connection reestablishment in a first PLMN, is associated with the first PLMN.

In some embodiments, the link failure is an RLF or an HOF declared by the UE in the first PLMN, and the failure report is an RLF report. In some embodiments, the failure report includes a list of PLMN identifiers associated with a cell in which the link failure occurred, including an identifier of the first PLMN. In some of these embodiments, the RNN is part of at least one of the PLMNs identified in the list. In some embodiments, the link failure occurred in a second cell associated with the first PLMN and the failed connection reestablishment occurred in a third cell associated with the first PLMN.

In different variants, the indication can have any of the forms and/or contents summarized above in relation to the UE embodiments.

In some embodiments, these exemplary methods can also include selectively performing mobility parameter tuning for the first cell based on the indication. For example, these operations can be part of self-optimizing network (SON) functionality, which is described in more detail below. In some embodiments, the selectively performing operations can include refraining from performing mobility parameter tuning for the first cell when the indication indicates that the first cell is not associated with the first PLMN in which the UE's failed connection reestablishment occurred.

Other embodiments include UEs (e.g., wireless devices, IoT devices, etc. or component(s) thereof) and RNNs (e.g., base stations, eNBs, gNBs, ng-eNBs, etc., or components thereof) configured to perform operations corresponding to any of the exemplary methods described herein. Other embodiments include non-transitory, computer-readable media storing program instructions that, when executed by processing circuitry, configure such UEs or RNNs to perform operations corresponding to any of the exemplary methods described herein.

Embodiments of the present disclosure facilitate correct interpretation by a network of various contents of a UE's RLF report. For example, based on the RLF report contents, the network node can identify whether the cell used for reconnection after a UE's RLF and failed reestablishment belongs to a PLMN identified in the list included in the RLF report. Accordingly, this allows the RNN to determine whether a mobility parameter tuning procedure is needed for this cell. In this manner, embodiments facilitate better and more accurate network tuning of mobility parameters and, thus, improved operation of the network.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 shows a high-level view of an exemplary LTE network architecture.

FIG. 2 shows an exemplary configuration of an LTE control plane (CP) protocol stack.

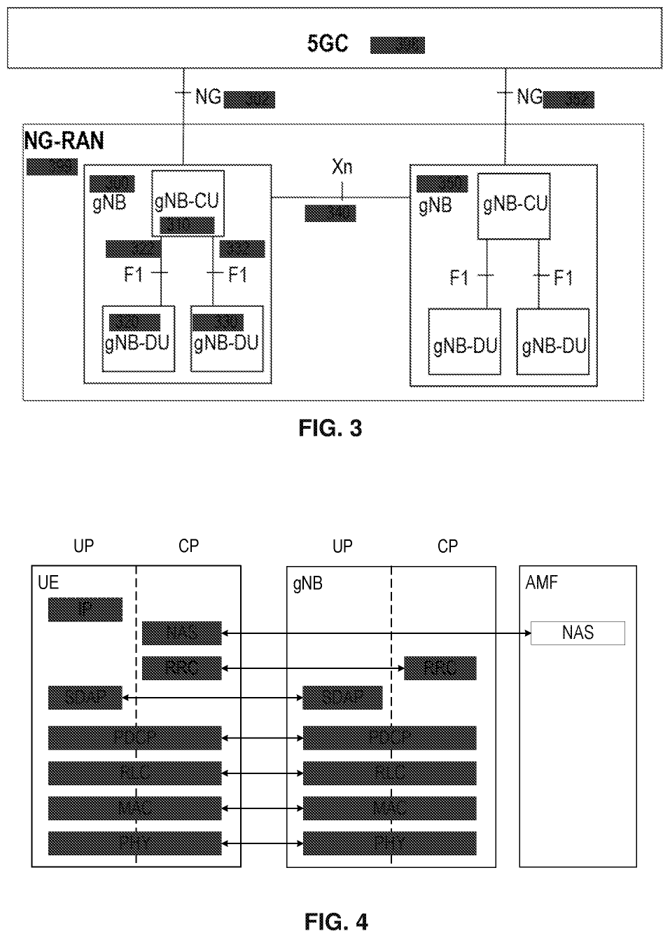

FIG. 3 shows a high-level view of an exemplary 5G/NR network architecture.

FIG. 4 shows an exemplary configuration of NR user plane (UP) and CP protocol stacks.

FIGS. 5-6 show high-level views of exemplary network architectures that support multi-RAT dual connectivity (MR-DC) using EPC and 5GC, respectively.

FIG. 7 is a block diagram showing a high-level comparison of control plane (CP) architectures for MR-DC using EPC and 5GC.

FIGS. 8-9 illustrate various aspects of UE's operation during an exemplary radio link failure (RLF) procedure in LTE and NR.

FIGS. 10-11 show signal flow diagrams of two scenarios in which a UE declares RLF in an NR source cell and then attempts an unsuccessful connection reestablishment in an LTE target cell.

FIG. 12, which includes FIGS. 12A-B, shows an exemplary ASN.1 data structure for a UEInformationResponse message, according to various embodiments of the present disclosure.

FIG. 13, which includes FIGS. 13A-B, shows an exemplary ASN.1 data structure for another variant of a UEInformationResponse message, according to other embodiments of the present disclosure.

FIG. 14 is a flow diagram of an exemplary method (e.g., procedure) for a UE (e.g., wireless device, IoT device, etc.), according to various embodiments of the present disclosure.

FIG. 15 is a flow diagram of an exemplary method (e.g., procedure) for a radio network node (RNN, e.g., base station, eNB, gNB, ng-eNB, en-gNB, etc.), according to various embodiments of the present disclosure.

FIG. 16 illustrates an embodiment of a wireless network.

FIG. 17 illustrates an embodiment of a UE.

FIG. 18 is a block diagram illustrating an exemplary virtualization environment usable for implementation of various embodiments of network nodes in a wireless network.

FIGS. 19-20 are block diagrams of various communication systems and/or networks, according to various embodiments of the present disclosure.

FIGS. 21-24 are flow diagrams of exemplary methods (e.g., procedures) for transmission and/or reception of user data, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Furthermore, the following terms are used throughout the description given below:
Radio Node: As used herein, a “radio node” can be either a “radio access node” or a “wireless device.”
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB/en-gNB) in a 3GPP Fifth Generation (5G) NR network or an enhanced or evolved Node B (eNB/ng-eNB) in a 3GPP LTE network), base station distributed components (e.g., CU and DU), base station control- and/or user-plane components (e.g., CU-CP, CU-UP), a high-power or macro base station, a low-power base station (e.g., micro, pico, femto, or home base station, or the like), an integrated access backhaul (IAB) node, a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), an access and mobility management function (AMF), a session management function (AMF), a user plane function (UPF), a Service Capability Exposure Function (SCEF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Some examples of a wireless device include, but are not limited to, smart phones, mobile phones, cell phones, voice over IP (VoIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc. Unless otherwise noted, the term “wireless device” is used interchangeably herein with the term “user equipment” (or “UE” for short).
Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.

Note that the description herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

As briefly mentioned above, conventional RLF reporting techniques have various problems, issues, and/or difficulties when a UE ultimately connects to an LTE cell after declaring RLF in an NR cell. This is discussed in more detail below, after the following description of NR network architecture and various dual connectivity (DC) arrangements.

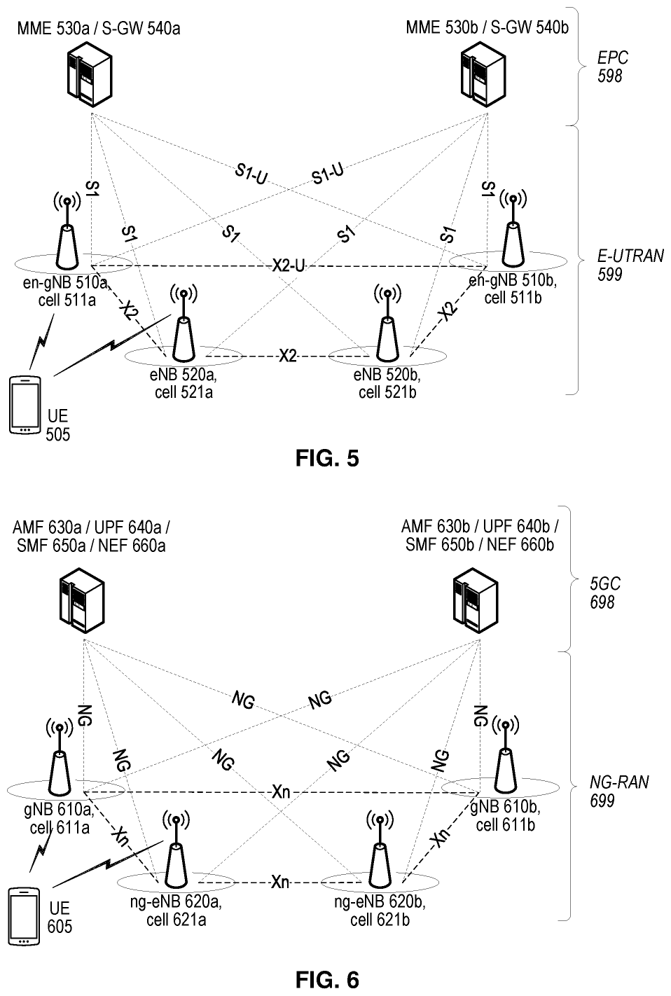

FIG. 3 illustrates a high-level view of the 5G network architecture, consisting of a Next Generation RAN (NG-RAN) 399 and a 5G Core (5GC) 398. NG-RAN 399 can include a set of gNodeB's (gNBs) connected to the 5GC via one or more NG interfaces, such as gNBs 300, 350 connected via interfaces 302, 352, respectively. In addition, the gNBs can be connected to each other via one or more Xn interfaces, such as Xn interface 340 between gNBs 300 and 350. With respect to the NR interface to UEs, each of the gNBs can support frequency division duplexing (FDD), time division duplexing (TDD), or a combination thereof.

NG-RAN 399 is layered into a Radio Network Layer (RNL) and a Transport Network Layer (TNL). The NG-RAN logical nodes and interfaces between them are part of the RNL. The TNL provides services for user plane (UP) transport and signaling transport, with TNL protocols and related functionality being specified for each NG-RAN interface (e.g., NG, Xn, F1). In some exemplary configurations, each gNB is connected to all 5GC nodes within an “AMF Region,” with the term AMF being discussed in more detail below.

The NG-RAN logical nodes shown in FIG. 3 include a central (or centralized) unit (CU or gNB-CU) and one or more distributed (or decentralized) units (DU or gNB-DU). For example, gNB 300 includes gNB-CU 310 and gNB-DUs 320 and 330. CUs (e.g., gNB-CU 310) are logical nodes that host higher-layer protocols and perform various gNB functions such controlling the operation of DUs. Each DU is a logical node that hosts lower-layer protocols and can include, depending on the functional split, various subsets of the gNB functions. As such, each of the CUs and DUs can include various circuitry needed to perform their respective functions, including processing circuitry, transceiver circuitry (e.g., for communication), and power supply circuitry. Moreover, the terms “central unit” and “centralized unit” are used interchangeably herein, as are the terms “distributed unit” and “decentralized unit.”

A gNB-CU connects to gNB-DUs over respective F1 logical interfaces, such as interfaces 322 and 332 shown in FIG. 3. The gNB-CU and connected gNB-DUs are only visible to other gNBs and the 5GC as a gNB. In other words, the F1 interface is not visible beyond gNB-CU. In the gNB split CU-DU architecture illustrated by FIG. 3, DC can be achieved by allowing a UE to connect to multiple DUs served by the same CU or by allowing a UE to connect to multiple DUs served by different CUs.

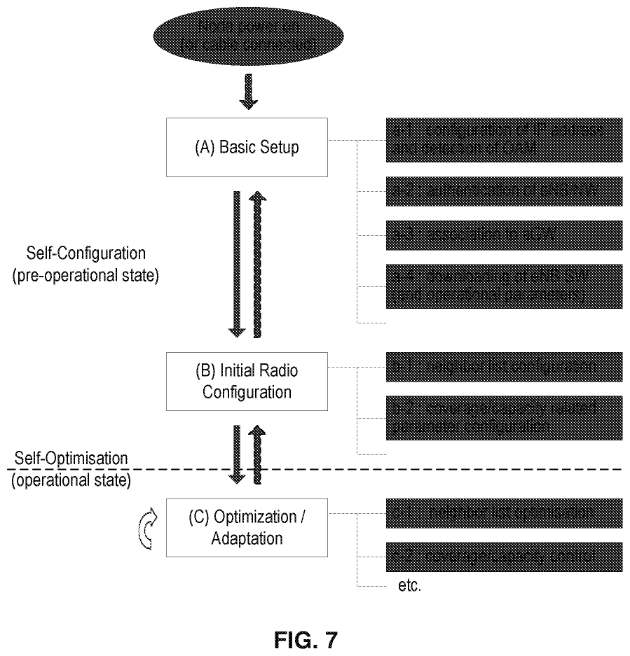

FIG. 4 shows an exemplary configuration of NR UP and control plane (CP) protocol stacks between a UE, a gNB, and an access and mobility management function (AMF) in the 5GC.

The PHY, MAC, RLC, and PDCP layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to the PDCP layer as service data units (SDUs), and PDCP creates protocol data units (PDUs) to deliver to RLC. When each IP packet arrives, PDCP starts a discard timer. When this timer expires, PDCP discards the associated SDU and the corresponding PDU. If the PDU was delivered to RLC, PDCP also indicates the discard to RLC. The RLC layer transfers PDCP PDUs to the MAC through logical channels (LCH). RLC provides error detection/correction, concatenation, segmentation/reassembly, sequence numbering, reordering of data transferred to/from the upper layers. If RLC receives a discard indication from associated with a PDCP PDU, it will discard the corresponding RLC SDU (or any segment thereof) if it has not been sent to lower layers.

The MAC layer provides mapping between LCHs and PHY transport channels, LCH prioritization, multiplexing into or demultiplexing from transport blocks (TBs), hybrid ARQ (HARQ) error correction, and dynamic scheduling (on gNB side). The PHY layer provides transport channel services to the MAC layer and handles transfer over the NR radio interface, e.g., via modulation, coding, antenna mapping, and beam forming.

On UP side, the Service Data Adaptation Protocol (SDAP) layer handles quality-of-service (QoS). This includes mapping between QoS flows and Data Radio Bearers (DRBs) and marking QoS flow identifiers (QFI) in UL and DL packets. On CP side, the NAS layer is between UE and AMF and handles UE/gNB authentication, mobility management, and security control.

The RRC layer sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs. RRC also performs various security functions such as key management.

After a UE is powered. ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB. An NR UE in RRC_IDLE state is not known to the gNB serving the cell where the UE is camping. However, NR RRC includes an RRC_INACTIVE state in which a UE is known (e.g., via UE context) by the serving gNB. RRC_INACTIVE has some properties similar to a “suspended” condition used in LTE.

LTE Rel-12 introduced dual connectivity (DC) whereby a UE in RRC_CONNECTED state can be connected to two network nodes simultaneously, thereby improving connection robustness and/or capacity. In LTE DC, these two network nodes are referred to as “Master eNB” (MeNB) and “Secondary eNB” (SeNB), or more generally as master node (MN) and secondary node (SN). More specifically, a UE is configured with a Master Cell Group (MCG) associated with the MN and a Secondary Cell Group (SCG) associated with the SN.

Each of these groups of serving cells include one MAC entity, a set of logical channels with associated RLC entities, a primary cell (PCell or PSCell), and optionally one or more secondary cells (SCells). The term “Special Cell” (or “SpCell” for short) refers to the PCell of the MCG or the PSCell of the SCG depending on whether the UE's MAC entity is associated with the MCG or the SCG, respectively. In non-DC operation (e.g., CA), SpCell refers to the PCell. An SpCell is always activated and supports physical uplink control channel (PUCCH) transmission and contention-based random access by UEs.

The MN provides SI and terminates the CP connection towards the UE and, as such, is the UE's controlling node, including for handovers to and from SNs. For example, the MN terminates the connection between the RAN (e.g., eNB) and the MME for an LTE UE. The reconfiguration, addition, and removal of SCells can be performed by RRC. When adding a new SCell, dedicated RRC signaling is used to send the UE all required SI of the SCell, such that UEs need not acquire SI directly from the SCell broadcast. In addition, either or both of the MCG and the SCG can include multiple cells working in CA.

Both MN and SN can terminate the UP to the UE. For example, the LTE DC UP includes three different types of bearers. MCG bearers are terminated in the MN, and the SN is not involved in the transport of UP data for MCG bearers. Likewise, SCG bearers are terminated in the SN, and the MN is not involved in the transport of UP data for SCG bearers. Finally, split bearers (and their corresponding S1-U connections to S-GW) are also terminated in MN. However, PDCP data is transferred between MN and SN via X2-U. Both SN and MN are involved in transmitting data for split bearers.

3GPP TR 38.804 (v14.0.0) describes various exemplary DC scenarios or configurations in which the MN and SN can apply NR, LTE, or both. The following terminology is used to describe these exemplary DC scenarios or configurations:
DC: LTE DC (i.e., both MN and SN employ LTE, as discussed above);
EN-DC: LTE-NR DC where MN (eNB) employs LTE and SN (gNB) employs NR, and both are connected to EPC.
NGEN-DC: LTE-NR dual connectivity where a UE is connected to one ng-eNB that acts as a MN and one gNB that acts as a SN. The ng-eNB is connected to the 5GC and the gNB is connected to the ng-eNB via the Xn interface.
NE-DC: LTE-NR dual connectivity where a UE is connected to one gNB that acts as a MN and one ng-eNB that acts as a SN. The gNB is connected to 5GC and the ng-eNB is connected to the gNB via the Xn interface.
NR-DC (or NR-NR DC): both MN and SN employ NR.
MR-DC (multi-RAT DC): a generalization of the Intra-E-UTRA Dual Connectivity (DC) described in 3GPP TS 36.300 (v16.3.0), where a multiple Rx/Tx UE may be configured to utilize resources provided by two different nodes connected via non-ideal backhaul, one providing E-UTRA access and the other one providing NR access. One node acts as the MN and the other as the SN. The MN and SN are connected via a network interface and at least the MN is connected to the core network. EN-DC, NE-DC, and NGEN-DC are different example cases of MR-DC.

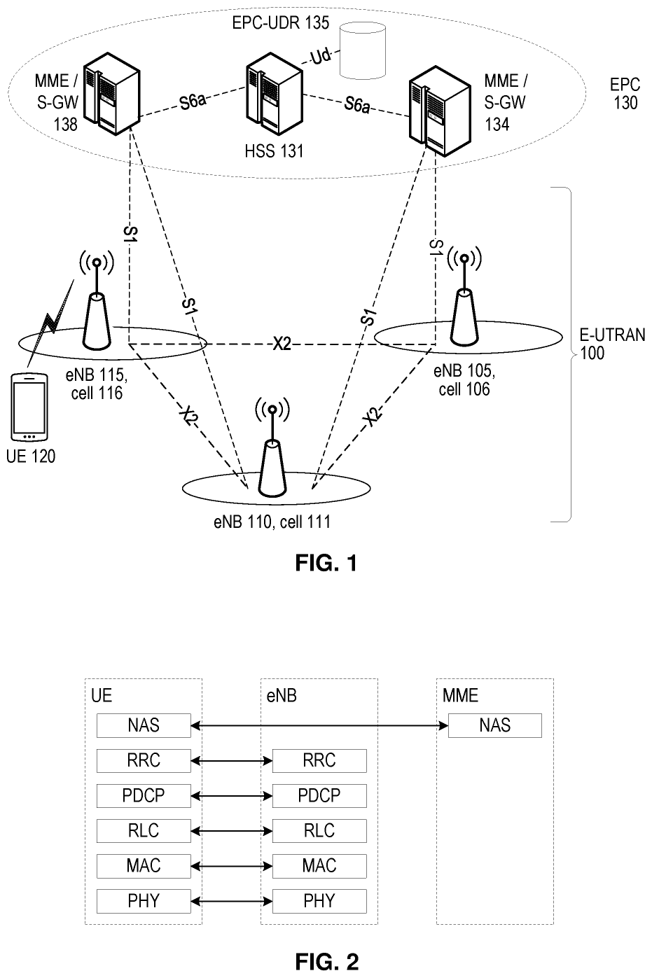

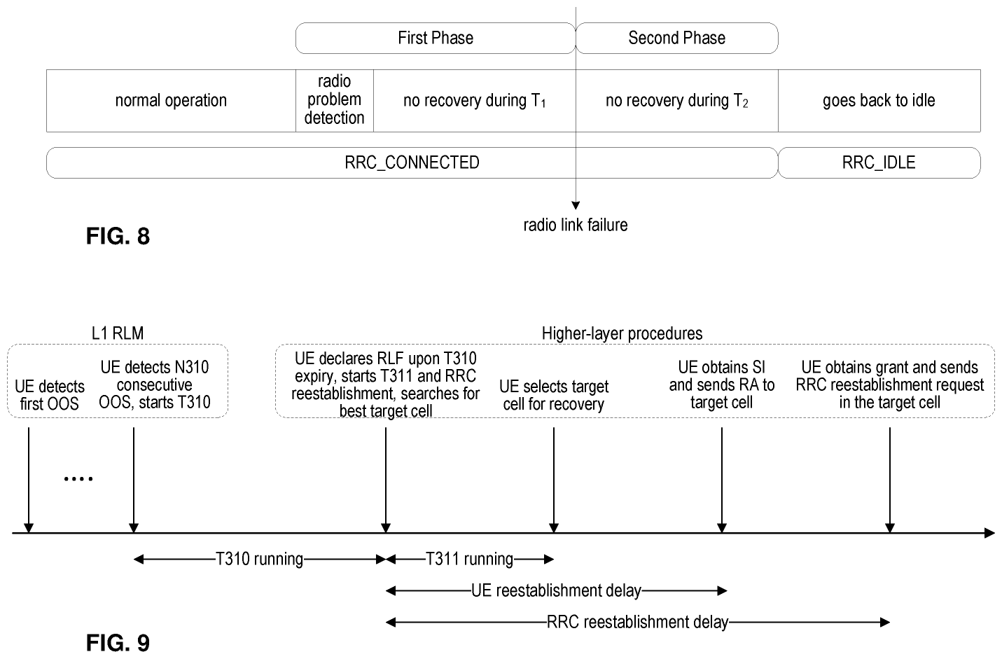

FIG. 5 shows a high-level view of an exemplary network architecture that supports EN-DC, including an E-UTRAN 599 and an EPC 598. As shown in the figure, E-UTRAN 599 can include en-gNBs (e.g., 510a,b) and eNBs (e.g., 520a,b) that are interconnected with each other via respective X2 (or X2-U) interfaces. The eNBs can be similar to those shown in FIG. 1, while the ng-eNBs can be similar to the gNBs shown in FIG. 3 except that they connect to EPC 598 via an S1-U interface rather than to a 5GC via an X2 interface. The eNBs also connect to EPC 598 via an S1 interface, similar to the arrangement shown in FIG. 1. More specifically, en-gNBs (e.g., 510a,b) and eNBs (e.g., 520a,b) connect to MMES (e.g., 530a,b) and S-GWs (e.g., 540a,b) in EPC 598.

Each of the en-gNBs and eNBs can serve a geographic coverage area including one more cells, including exemplary cells 511a-b and 521a-b shown in FIG. 5. Depending on the cell in which it is located, a UE 505 can communicate with the en-gNB or eNB serving that cell via the NR or LTE radio interface, respectively. In addition, UE 505 can be in EN-DC connectivity with a first cell served by an eNB and a second cell served by an en-gNB, such as cells 520a and 510a shown in FIG. 5.

FIG. 6 shows a high-level view of an exemplary network architecture that supports MR-DC configurations based on a 5GC. More specifically, FIG. 6 shows an NG-RAN 699 and a 5GC 698. NG-RAN 699 can include gNBs (e.g., 610a,b) and ng-eNBs (e.g., 620a,b) that are interconnected with each other via respective Xn interfaces. The gNBs and ng-eNBs are also connected via the NG interfaces to 5GC 698, more specifically to the AMFs (e.g., 630a,b) via respective NG-C interfaces and to the User Plane Functions (UPFs, e.g., 640a,b) via respective NG-U interfaces. Moreover, the AMFs can communicate with one or more session management functions (SMFs, e.g., 650a,b) and network exposure functions (NEFs, e.g., 660a,b).

Each of the gNBs can be similar to those shown in FIG. 3, while each of the ng-eNBs can be similar to the eNBs shown in FIG. 1 except that they connect to 5GC 698 via an NG interface rather than to an EPC via an S1 interface. Each of the gNBs and ng-eNBs can serve a geographic coverage area including one more cells, including exemplary cells 611a-b and 621a-b shown in FIG. 6. The gNBs and ng-eNBs can also use various directional beams to provide coverage in the respective cells. Depending on the cell in which it is located, a UE 605 can communicate with the gNB or ng-eNB serving that cell via the NR or LTE radio interface, respectively. In addition, UE 605 can be in MR-DC connectivity with a first cell served by an ng-eNB and a second cell served by a gNB, such as cells 620a and 610a shown in FIG. 6.

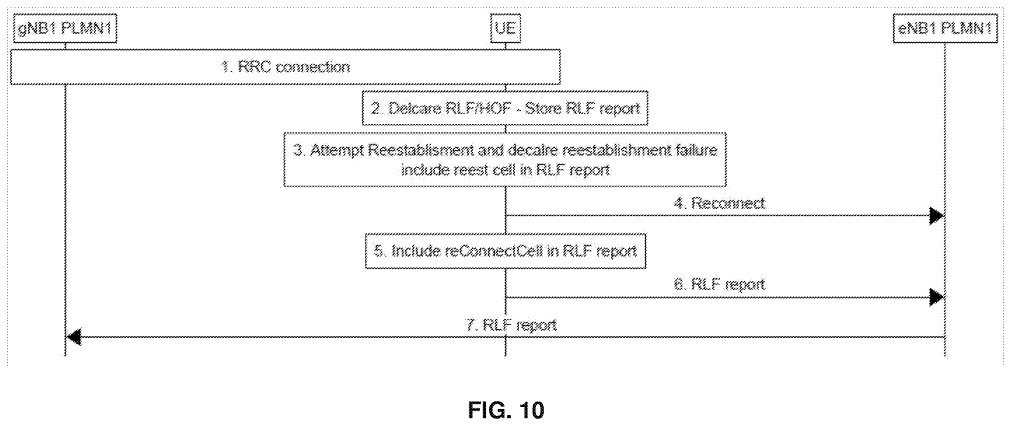

A primary goal of Self-Organizing Network (SON) functionality is to make planning, configuration, management, optimization, and healing of RANs simpler and faster. SON functionality and behavior has been defined and specified in by organizations such as 3GPP and NGMN (Next Generation Mobile Networks). FIG. 7 is a high-level diagram illustrating 3GPP's division of SON functionality into a self-configuration process and a self-optimization process.

Self-configuration is a pre-operational process in which newly deployed nodes (e.g., eNBs or gNBs in a pre-operational state) are configured by automatic installation procedures to get the necessary basic configuration for system operation. Pre-operational state generally refers to the time when the node is powered up and has backbone connectivity until the node's RF transmitter is switched on. Self-configuration operations in pre-operational state include (A) basic setup and (B) initial radio configuration, which include the following sub-operations shown in FIG. 7:
(a-1) Configuration of IP address and detection of operations administration and maintenance (OAM);
(a-2) Authentication of eNB/network;
(a-3) Associate to access gateway (aGW);
(a-4) Downloading of eNB software (SW) and operational parameters;
(b-1) Neighbor list configuration; and
(b-2) Coverage/capacity-related parameter configuration.

Self-optimization is a process in which UE and network measurements are used to auto-tune the network. This occurs when the nodes are in operational state, which generally refers to when a node's RF transmitter interface is switched on. Self-configuration operations include optimization and adaptation, which includes the following sub-operations shown in FIG. 7:
(c-1) Neighbor list optimization; and
(c-2) Coverage/capacity control.

Self-configuration and self-optimization features for LTE networks are described in 3GPP TS 36.300 (v16.5.0) section 22.2. These include dynamic configuration, automatic neighbor relations (ANR), mobility load balancing (MLB), mobility robustness optimization (MRO), RACH optimization, and support for energy savings. Self-configuration and self-optimization features for NR networks are described in 3GPP TS 38.300 (v16.5.0) section 15. Rel-15 features include dynamic configuration and ANR. Rel-16 includes additional features such as MRO.

Returning to discussion of RLF, a network can configure a UE in RRC_CONNECTED state to perform and report RRM measurements that assist network-controlled mobility decisions such as UE handover between cells, SN change, etc. The UE may lose coverage in its current serving cell (e.g., PCell in DC) and attempt handover to a target cell. Similarly, a UE in DC may lose coverage in its current PSCell and attempt an SN change. Other events may trigger other mobility-related procedures.

A UE typically triggers an internal RLF procedure when something unexpected happens in any of these mobility-related procedures. The RLF procedure involves interactions between RRC and lower layer protocols such as PHY (or L1), MAC, RLC, etc. including radio link monitoring (RLM) on L1.

The principle of RLM is similar in LTE and NR. In general, the UE monitors link quality of the UE's serving cell (i.e., SpCell) and uses that information to decide whether the UE is in-sync (IS) or out-of-sync (OOS) with respect to that serving cell. In LTE, RLM is involves the UE measuring downlink reference signals (e.g., CRS) in RRC_CONNECTED state. If RLM (i.e., by L1/PHY) indicates number of consecutive OOS conditions to the UE RRC layer, then RRC starts a radio link failure (RLF) procedure and declares RLF after expiry of a timer (e.g., T310). The L1 RLM procedure is carried out by comparing the estimated CRS measurements to some targets Qout and Qin, which correspond to block error rates (BLERs) of hypothetical PDCCH/PCIFCH transmissions from the serving cell. Exemplary values of Qout and Qin are 10% and 2%, respectively. In NR, the network can define RS type (e.g., CSI-RS and/or SSB), exact resources to be monitored, and the BLER target for IS and OOS indications.

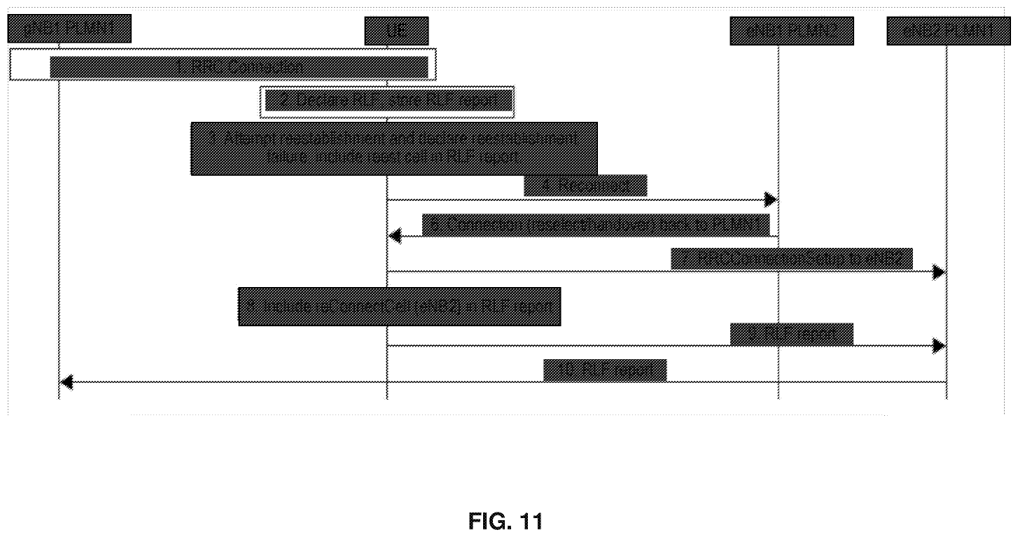

FIG. 8 shows a high-level timing diagram illustrating the two phases of an RLF procedure in LTE and NR. The first phase starts upon radio problem detection and leads to radio link failure detection if there is no recovery during a period T1. The second phase starts upon RLF detection or handover failure and ends with the UE returning to RRC_IDLE if there is no recovery during a period T2.

FIG. 9 shows a more detailed version of the UE's operations during an exemplary RLF procedure, such as for LTE or NR. In this example, the UE detects N310 consecutive OOS conditions during L1 RLM procedures, as discussed above, and then initiates timer T310. Subsequent operations are performed by higher layers (e.g., RRC). After expiry of T310, the UE declares RLF and starts T311 and RRC reestablishment, searching for the best target cell. After selecting a target cell, the UE obtains system information (SI) for the target cell and performs a random access (e.g., via RACH). The duration after T310 expiry until this point can be considered the UE's reestablishment delay. Ultimately, the UE obtains access to the target cell and sends an RRC Reestablishment Request message to the target cell. The duration after T310 expiry until this point can be considered the total RRC reestablishment delay. If the UE does not successfully reestablish in a target cell before expiration of T311, the UE enters RRC_IDLE and releases its connection to the network.

Tables 1-2 below provide more details about the timers and counters described above. For NR-DC and NGEN-DC, T310 is used for both PCell/MCG and PSCell/SCG. For LTE-DC and NE-DC (i.e., where SN is eNB), T313 is used for PSCell/SCG. The UE reads the timer values from system information (SI) broadcast in the UE's SpCell. Alternatively, the network can configure the UE with UE-specific values of the timers and constants via dedicated RRC signaling (i.e., specific values sent to specific UEs via respective messages).

TABLE 1

| Timer | Start | Stop | At expiry |
|---|---|---|---|
| T310 | Upon detecting physical layer | Upon receiving N311 consecutive | If the T310 is kept in MCG: |
| | problems for the SpCell i.e. | in-sync indications from lower | If AS security is not activated: |
| | upon receiving N310 consecutive | layers for the SpCell, upon | go to RRCIDLE else: initiate |
| | out-of-sync indications | receiving RRCReconfiguration | the connection re-establishment |
| | from lower layers. | with reconfigurationWithSync | procedure. If the T310 is kept in |
| | | for that cell group, and upon | SCG, Inform E-UTRAN/NR about |
| | | initiating the connection | the SCG radio link failure by |
| | | re-establishment procedure. | initiating the SCG failure |
| | | Upon SCG release, if the T310 | information procedure as specified |
| | | is kept in SCG. | in 5.7.3. |
| T311 | Upon initiating the RRC | Upon selection of a suitable | Enter RRC_IDLE |
| | connection re-establishment | NR cell or a cell using | |
| | procedure | another RAT. | |
| T313 | Upon detecting physical layer | Upon receiving N314 consecutive | Inform E-UTRAN about the SCG |
| | problems for the PSCell i.e. upon | in-sync indications from lower | radio link failure by initiating |
| | receiving N313 consecutive | layers for the PSCell, upon | the SCG failure information |
| | out-of-sync indications from | initiating the connection re- | procedure as specified in 5.6.13. |
| | lower layers | establishment procedure, upon | |
| | | SCG release and upon receiving | |
| | | RRCConnectionReconfiguration | |
| | | including | |
| | | MobilityControlInfoSCG | |

TABLE 2

| Constant | Usage |
|---|---|
| N310 | Maximum number of consecutive “out-of-sync” indications |
| | for the SpCell received from lower layers |
| N311 | Maximum number of consecutive “in-sync” indications |
| | for the SpCell received from lower layers |
| N313 | Maximum number of consecutive “out-of-sync” indications |
| | for the PSCell received from lower layers (for LTE SN) |

One reason for introducing the timers and counters listed above is to add some filtering, delay, and/or hysteresis to a UE's determination of failure and/or recovery of a radio link with a serving cell. These parameters avoid a UE abandoning a connection prematurely due to a brief or temporary reduction in link quality that could be recovered by the UE (e.g., before T310 expires, before the counter value N310, etc.). In general, this improves user experience.

In case of handover failure (HOF) and RLF, the UE may take autonomous actions such as selecting a cell and initiating reestablishment to remain reachable by the network. In general, a UE declares RLF only when the UE realizes that there is no reliable communication channel (or radio link) available between itself and the network, which can result in poor user experience. Also, reestablishing the connection requires signaling with a newly selected cell (e.g., random access procedure, exchanging various RRC messages, etc.), which introduces latency until the UE can again reliably transmit and/or receive user data with the network. According to 3GPP TS 36.331 (v15.7.0), potential causes for RLF include:
1) Radio link problem indicated by PHY (e.g., expiry of RLM-related timer T310);
2) Random access problem indicated by MAC entity;
3) Expiry of a measurement reporting timer (e.g., T312), due to not receiving a HO command from the network while the timer is running despite sending a measurement report; and
4) Reaching a maximum number of RLC retransmissions.

Since RLF leads to reestablishment in a new cell and degradation of UE/network performance and end-user experience, it is in the interest of the network to understand the reasons for UE RLF and to optimize mobility-related parameters (e.g., trigger conditions of measurement reports) to reduce, minimize, and/or avoid subsequent RLFs. Before Rel-9 mobility robustness optimizations (MRO), only the UE was aware of radio quality at the time of RLF, the actual reason for declaring RLF, etc. To identify the RLF cause, the network requires more information from the UE and from the neighboring base stations (e.g., eNBs).

An RLF reporting procedure was introduced as part of MRO for NR Rel-16. In this procedure, a UE logs relevant information at the time of RLF and later reports such information to the network via a target cell to which the UE ultimately connects (e.g., after reestablishment). The UE can store the RLF report in a UE variable call varRLF-Report and retains it in memory for up to 48 hours, after which it may discard the information.

When sending certain RRC messages such as RRCReconfigurationComplete, RRCReestablishmentComplete, RRCSetup-Complete, and RRCResumeComplete, the UE can indicate it has a stored RLF report by setting a rlf-InfoAvailable field to “true.” If the gNB serving the target cell wants to receive the RLF report, it sends the UE an UEInformationRequest message with a flag “rlf-ReportReq-r16”. In response, the UE sends the gNB an UEInformationResponse message that includes the RLF report.

In general, the UE-reported RLF information can include any of the following:
Measurement quantities (RSRP, RSRQ) of the last serving cell (PCell).
Measurement quantities of the neighbor cells in different frequencies of different RATs (e.g., EUTRA, UTRA, GERAN, CDMA2000).
Measurement quantity (RSSI) associated to WLAN APs.
Measurement quantity (RSSI) associated to Bluetooth beacons.
Location information, if available (including location coordinates and velocity)
Globally unique identity of the last serving cell, if available, otherwise the PCI and the carrier frequency of the last serving cell.
Tracking area code of the PCell.
Time elapsed since the last reception of the ‘Handover command’ message.
C-RNTI used in the previous serving cell.
Whether or not the UE was configured with a DRB having QCI=1.

The RLF reporting procedure not only introduced new RRC signaling between UE and the network (e.g., a target gNB hosting the target cell), but also introduced signaling between nodes in the network (e.g., XnAP signaling specified in 3GPP TS 38.423 v16.4.0). For example, a gNB receiving an RLF report could forward some or all of the report to the gNB in which the RLF originated. 3GPP TS 38.423 specifies two types of inter-node messages for sending RLF reports between nodes: Failure indication and Handover report.

Based on a globally unique identity of the UE's last serving cell included in the RLF report, the node serving the target cell (i.e., the UE's new serving cell) can determine the cell where the RLF originated and forward the RLF report to the source gNB serving that cell. Based on this RLF report, the source gNB can deduce whether the UE's RLF in that cell was caused due to a coverage hole or due to handover-related parameter configurations. In case of the latter cause, the source gNB can further classify the handover related failure according to too-early, too-late, or handover-to-wrong-cell classes.

The source gNB can classify a handover failure as “too late handover” when the original serving cell fails to send the handover command to the UE associated to a handover towards a particular target cell and if the UE reestablishes itself in this target cell post-RLF. An example corrective action by the source gNB could be to initiate the handover procedure from the source cell towards this target cell slightly earlier by decreasing the cell individual offset (CIO) towards the target cell. The CIO controls when the IE sends the event triggered measurement report that leads to taking the handover decision.

The source gNB can classify a handover failure as “too early handover” when the original serving cell is successful in sending the handover command to the UE but the UE fails to perform the random access towards the target cell. An example corrective action by the source gNB could be to initiate the handover procedure from the source cell towards this target cell slightly later by increasing the CIO towards the target cell.

The source gNB can classify a handover failure to be “handover-to-wrong-cell” when the original serving cell intends to perform the handover for this UE towards a particular target cell but the UE declares RLF and reestablishes itself in a different target cell. A corrective action by the source gNB could be to initiate the measurement reporting procedure that leads to handover from the source cell towards the target cell slightly later by decreasing the CIO, or by initiating the handover towards the different target cell in which the UE reestablished slightly earlier by increasing the CIO towards the different target cell.

For Rel-16, a reconnectCellID parameter was added to the RLF report in both LTE and NR specifications. This information is supposed to identify an LTE cell in which the UE reestablished its connection after declaring RLF in an NR cell. This scenario was expected to occur frequently during initial NR deployments in which UEs were expected to be “retained” in NR cells for as long as possible, thus risking too-late inter-RAT handovers to LTE. By obtaining the identity of the LTE target cell where RLF occurred, the NR source cell can improve the inter-RAT handover parameters towards this LTE cell and thus reduce the probability of future RLFs.

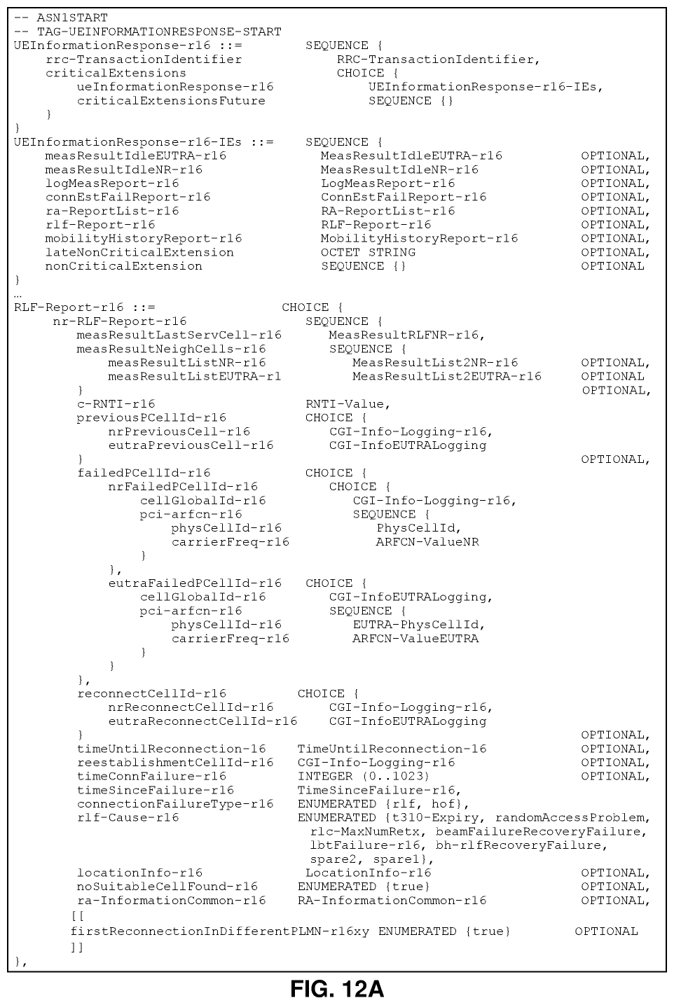

As currently specified, the UE records reconnectCellID if the reconnection occurs in the same PLMN as the RLF or in a PLMN that is part of the UE's stored plmn-IdentityList. The intention of the reconnectCellID is to capture the first cell in which the UE reconnects after the RLF/HOF was declared by the UE and failing in the subsequent reestablishment. FIG. 10 shows a signal flow diagram of a scenario where a UE declares RLF (operation 2) of an RRC connection (established in operation 1) in an NR cell served by gNB1 in PLMN1. In operations 3-4, the UE attempts an unsuccessful reestablishment in a target cell (reest-cell) and later reconnects to a target cell served by eNB1 in PLMN1, which is the same PLMN in which the unsuccessful reestablishment occurred. In operations 5-6, the UE sends an RLF report to eNB1 and includes reconnectCellID for the target cell served by eNB1 in the RLF report. In operation 7, eNB1 sends the RLF report to gNB1 in PLMN1, to which the

The following 3GPP procedural text also illustrates the UE's operations in FIG. 10:

```
*** Begin 3GPP procedural text ***
  1>if the UE has radio link failure or handover failure information available in VarRLF-
    Report and if the RPLMN is included in plmn-IdentityList stored in VarRLF-Report:
    2>if reconnectCellID in VarRLF-Report is not set:
      3>set time UntilReconnection in VarRLF-Report to the time that elapsed since the last
        radio link failure or handover failure;
      3>set nrReconnectCellId in reconnectCellID in VarRLF-Report to the global cell
        identity and the tracking area code of the PCell;
  1>if the UE supports RLF report for inter-RAT MRO NR as defined in TS 36.306 [62], and
    if the UE has radio link failure or handover failure information available in VarRLF-
    Report of TS 36.331 [10] and if the RPLMN is included in plmn-IdentityList stored in
    VarRLF-Report of TS 36.331 [10]:
    2>if reconnectCellID in VarRLF-Report of TS 36.331[10] is not set:
    3>set time UntilReconnection in VarRLF-Report of TS 36.331[10] to the time that
      elapsed since the last radio link failure or handover failure in LTE;
    3>set nrReconnectCellId in reconnectCellID in VarRLF-Report of TS 36.331[10] to
      the global cell identity and the tracking area code of the PCell;
*** End 3GPP procedural text ***
```

FIG. 11 shows a signal flow diagram of another exemplary scenario in which a UE declares RLF (operation 2) of an RRC connection (established in operation 1) in an NR cell served by gNB1 of PLMN1. In this scenario, the UE fails to reestablish the connection with gNB1 (operation 3) but then reestablishes a connection (operation 4) with a target cell served by eNB1 of PLMN2, i.e., a different PLMN. In this scenario, the UE does not include reconnectCellID for the target cell served by eNB1 in the RLF report sent to eNB1, since PLMN2 is different than PLMN1 where the RLF occurred. Furthermore, PLMN2 is not part of the UE's stored plmn-IdentityList. In operations 5-7, the UE later reconnects to a target cell served by eNB2 of PLMN1. In operations 8-9, the UE includes reconnectCellID for the target cell in the RLF report sent to eNB2, according to above procedural text.

In summary, when the cell in which the UE first reconnects after RLF and failed reestablishment belongs to a PLMN that is not part of the UE's plmn-IdentityList, the UE does not include that cell as the reconnectCellID in the RLF report. Rather, reconnectCellID included by the UE in such scenarios is the cell in the UE's plmn-IdentityList to which the UE first reconnects (i.e., transmits an RRCSetup or RRCConnectionSetup message) after the RLF and failed reestablishment. However, this behavior does not meet the intent of having reconnectCellID in the RLF report, which is to capture the first cell to which the UE reconnects after RLF and failed reestablishment. As such, a network node receiving an RLF report may misinterpret this information, causing it to unnecessarily adjust parameters (e.g., CIO) of the cells that it serves.

Accordingly, embodiments of the present disclosure provide techniques that ensure the reconnectCellID information included in the RLF report can be correctly interpreted by a receiving network node. Based on RLF report contents, the network node can identify whether the cell used for reconnection after the RLF/HOF and failed reestablishment belongs to the same PLMN as the in plmn-IdentityList stored in the RLF report. Accordingly, the network node can determine whether a mobility parameter tuning procedure should be used for the reconnectCellID included in the RLF report. For example, if the reconnectCellID included in the RLF report is not the first cell after failed reestablishment, then the network node can refrain from performing any mobility parameter tuning of the cell identified by reconnectCellID. In this manner, embodiments facilitate improved network tuning of mobility parameters.

In some embodiments, a UE does not include reconnectCellID in the RLF report if the cell in which the UE first reconnected after RLF and subsequent failed reestablishment belongs to a PLMN that is not listed in plmn-IdentityList stored in the RLF report. In some cases, however, this approach may be sub-optimal since the reconnectCellID included in the RLF report serves as an indirect identifier that reestablishment has failed. If the UE does not include reconnectCellID in scenarios where the first cell in which the UE reconnected after the RLF and subsequent failed reestablishment belongs to a PLMN that is not listed in plmn-IdentityList stored in the RLF report, then the network cannot deduce based on the RLF report as to whether or not reestablishment was successful.

These embodiments are also illustrated by the following procedural text, which can be part of an NR RRC standard such as 3GPP TS 38.331 (v16.4.1). Note that this text may omit certain operations performed by the UE for the sake of brevity, and can be combined with existing text in 3GPP TS 38.331 (v16.4.1).

```
*** Begin 3GPP procedural text ***
The UE shall perform the following actions upon reception of the RRCSetup:
  . . .
  1>if the UE has radio link failure or handover failure information available in VarRLF-
    Report and if the RPLMN is included in plmn-IdentityList stored in VarRLF-Report:
    2>if reconnectCellID in VarRLF-Report is not set and if this is the first RRCSetup
      received by the UE after declaring RLF/HOF:
      3>set time UntilReconnection in VarRLF-Report to the time that elapsed since the last
        radio link failure or handover failure;
      3>set nrReconnectCellId in reconnectCellID in VarRLF-Report to the global cell
        identity and the tracking area code of the PCell;
  1>if the UE supports RLF report for inter-RAT MRO NR as defined in TS 36.306 [62], and
    if the UE has radio link failure or handover failure information available in VarRLF-
    Report of TS 36.331 [10] and if the RPLMN is included in plmn-IdentityList stored in
    VarRLF-Report of TS 36.331 [10]:
    2>if reconnectCellID in VarRLF-Report of TS 36.331 [10] is not set and if this is the first
    RRCSetup received by the UE after declaring RLF/HOF:
      3>set time UntilReconnection in VarRLF-Report of TS 36.331[10] to the time that
        elapsed since the last radio link failure or handover failure in LTE;
      3>set nrReconnectCellId in reconnectCellID in VarRLF-Report of TS 36.331 [10] to
        the global cell identity and the tracking area code of the PCell;
        . . .
  1>submit the RRCSetupComplete message to lower layers for transmission, upon which the
    procedure ends.
*** End 3GPP procedural text ***
```

These embodiments are also illustrated by the following procedural text, which can be part of an LTE RRC standard such as 3GPP TS 36.331 (v16.4.0). Note that this text may omit certain operations performed by the UE for the sake of brevity, and can be combined with existing text in 3GPP TS 36.331 (v16.4.0).

```
*** Begin 3GPP procedural text ***
The UE shall [upon reception of RRCConnectionSetup]:
  . . .
  1>except for NB-IoT:
    2>if the UE supports RLF report for inter-RAT MRO EUTRA as defined in TS 38.306
      [87], and if the UE has radio link failure or handover failure information available in
      VarRLF-Report of TS 38.331 [82] and if the RPLMN is included in plmn-IdentityList
      stored in VarRLF-Report of TS 38.331 [82]:
      3>if reconnect Cellid in VarRLF-Report of TS 38.331 [82] is not set and if this is the
        first RRCSetup received by the UE after declaring RLF/HOF:
        4>set time UntilReconnection in VarRLF-Report of TS 38.331 [82] to the time that
          elapsed since the last radio link failure or handover failure;
        4>set eutraReconnectCellId in reconnectCellId in VarRLF-Report of TS 38.331 [82]
          to the global cell identity and the tracking area code of the PCell;
  1>set the content of RRCConnectionSetupComplete message as follows:
      . . .
    2>if the UE is connected to EPC:
      3>except for NB-IoT:
        4>if the UE has radio link failure or handover failure information available in
          VarRLF-Report and if the RPLMN is included in plmn-IdentityList stored in
          VarRLF-Report:
          5>if reconnectCellID in VarRLF-Report is not and if this is the first RRCSetup
            received by the UE after declaring RLF/HOF:
            6>set time UntilReconnection in VarRLF-Report to the time that elapsed since
              the last radio link failure or handover failure;
            6>set eutraReconnectCellId in reconnectCellID in VarRLF-Report to the
              global cell identity and the tracking area code of the PCell;
          5>include rlf-InfoAvailable;
      . . .
  1>submit the RRCConnectionSetupComplete message to lower layers for transmission;
  1>the procedure ends.
*** Begin 3GPP procedural text ***
```

In other embodiments, a UE can include an indicator in the RLF report when the reconnectCellID (included in the RLF report) is not the first cell in which the UE reconnected after the RLF and subsequent failed reestablishment. These embodiments have the advantage and/or benefit that the network node can determine, based on the contents RLF report, whether the reestablishment was successful and whether reconnectCellID in the RLF report was the first cell in which the UE reconnected (e.g., whether or not the first reconnection happened in a cell belonging to a different PLMN).

These embodiments can be further illustrated by the following procedural text, which can be part of an NR RRC standard such as 3GPP TS 38.331 (v16.4.1). Note that this text may omit certain operations performed by the UE for the sake of brevity, and may be combined with existing text in 3GPP TS 38.331 (v16.4.1).

```
*** Begin 3GPP procedural text ***
The UE shall perform the following actions upon reception of the RRCSetup:
  . . .
  1>if the UE has radio link failure or handover failure information available in VarRLF-
    Report:
    2>if this is the first RRCSetup received by the UE after declaring RLF/HOF and if the
      RPLMN is not included in plmn-IdentityList stored in VarRLF-Report:
      3>set firstReconnectionInDifferentPLMN in VarRLF-Report to true;
    2>if reconnectCellID in VarRLF-Report is not set:
      3>if the RPLMN is included in plmn-IdentityList stored in VarRLF-Report:
```

| | |
|---|---|
| 4> | set time UntilReconnection in VarRLF-Report to the time that elapsed since the last |
| | radio link failure or handover failure; |
| 4> | set nrReconnectCellId in reconnectCellID in VarRLF-Report to the global cell |
| | identity and the tracking area code of the PCell; |

```
  1>if the UE supports RLF report for inter-RAT MRO NR as defined in TS 36.306 [62], and
    if the UE has radio link failure or handover failure information available in VarRLF-
    Report of TS 36.331 [10]:
    2>if this is the first RRCSetup received by the UE after declaring RLF/HOF and if the
      RPLMN is not included in plmn-IdentityList stored in VarRLF-Report of TS 36.331
      [10:
      3> set firstReconnectionInDifferentPLMN in VarRLF-Report of TS 36.331 [10 to true;
    2>if reconnectCellID in VarRLF-Report of TS 36.331[10] is not set:
      3>if the RPLMN is included in plmn-IdentityList stored in VarRLF-Report of TS
        36.331 [10]:
        4> set time UntilReconnection in VarRLF-Report of TS 36.331[10] to the time that
          elapsed since the last radio link failure or handover failure in LTE;
        4> set nrReconnectCellId in reconnectCellID in VarRLF-Report of TS 36.331[10]
          to the global cell identity and the tracking area code of the PCell;
        . . .
  1>submit the RRCSetupComplete message to lower layers for transmission, upon which the
    procedure ends.
*** End 3GPP procedural text ***
```

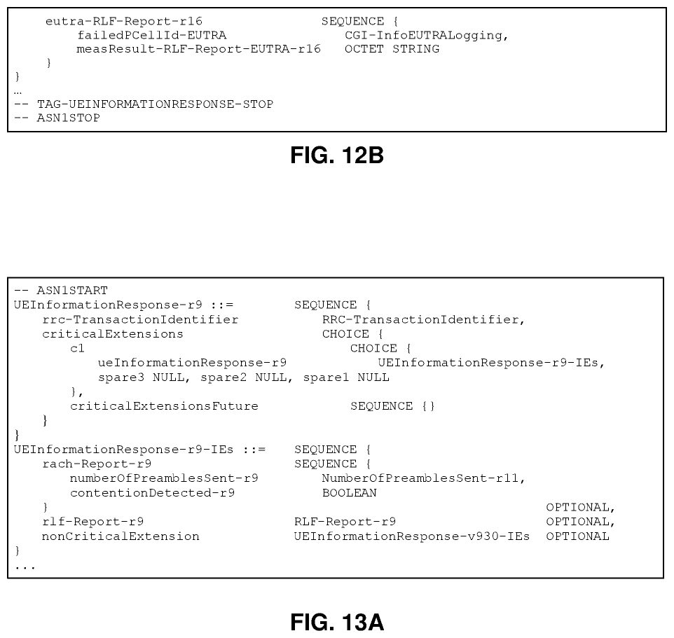

FIG. 12, which includes FIGS. 12A-B, shows an ASN.1 data structure for an exemplary UEInformationResponse message that includes an RLF-Report-r16 information element (IE) in accordance with the above exemplary procedural text for NR RRC. This IE includes an optional firstReconnectionInDifferentPLMN-r16xy field that, if present indicates that the first cell in which the UE performed RRC connection setup after declaring RLF/HOF and failing to perform reestablishment belongs to a different PLMN than the plmn-IdentityList stored in VarRLF-Report.

These embodiments can also be illustrated by the following procedural text, which can be part of an LTE RRC standard such as 3GPP TS 36.331 (v16.4.0). Note that this text may omit certain operations performed by the UE for the sake of brevity, and may be combined with existing text in 3GPP TS 36.331 (v16.4.0).

```
*** Begin 3GPP procedural text ***
The UE shall [upon reception of RRCConnectionSetup]:
  . . .
  1>except for NB-IoT:
    2>if the UE supports RLF report for inter-RAT MRO EUTRA as defined in TS 38.306
      [87], and if the UE has radio link failure or handover failure information available in
      VarRLF-Report of TS 38.331 [82]:
      3>if this is the first RRCSetup received by the UE after declaring RLF/HOF and if the
        RPLMN is not included in plmn-IdentityList stored in VarRLF-Report of TS 38.331
        [82]:
        4>set firstReconnectionInDifferentPLMN in VarRLF-Report of TS 38.331 [82]to
            true;
      3>if reconnectCellId in VarRLF-Report of TS 38.331 [82] is not set:
        4>if the RPLMN is included in plmn-IdentityList stored in VarRLF-Report of TS
          38.331 [82]
          5>set time UntilReconnection in VarRLF-Report of TS 38.331 [82] to the time
            that elapsed since the last radio link failure or handover failure;
          5>set eutraReconnectCellId in reconnectCellId in VarRLF-Report of TS 38.331
            [82] to the global cell identity and the tracking area code of the PCell;
    . . .
  1>set the content of RRCConnectionSetupComplete message as follows:
    2>if the UE is connected to EPC:
      3>except for NB-IoT:
        4>if the UE has radio link failure or handover failure information available in
          VarRLF-Report:
        4> if this is the first RRCSetup received by the UE after declaring RLF/HOF and if
          the RPLMN is not included in plmn-IdentityList stored in VarRLF-Report:
          5>set firstReconnectionInDifferentPLMN in VarRLF-Report to true;
          5>if reconnectCellID in VarRLF-Report is not set:
            6>if the RPLMN is included in plmn-IdentityList stored in VarRLF-Report:
              7> set time UntilReconnection in VarRLF-Report to the time that elapsed
                since the last radio link failure or handover failure;
              7> set eutraReconnectCellId in reconnectCellID in VarRLF-Report to the
                global cell identity and the tracking area code of the PCell;
          5> if the RPLMN is included in plmn-IdentityList stored in VarRLF-Report:
            6> include rlf-InfoAvailable;
. . .
  1>submit the RRCConnectionSetupComplete message to lower layers for transmission;
  1>the procedure ends.
*** End 3GPP procedural text ***
```

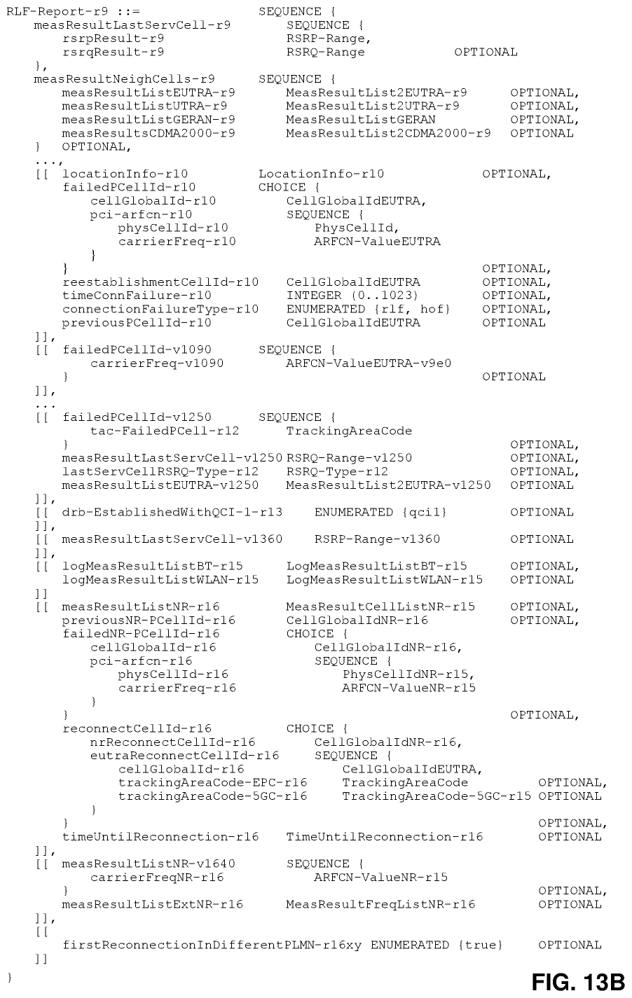

FIG. 13, which includes FIGS. 13A-B, shows an ASN.1 data structure for an exemplary UEInformationResponse message that includes an RLF-Report-r9 IE (shown in FIG. 13B) in accordance with the above exemplary procedural text for LTE RRC. This IE includes an optional firstReconnectionInDifferentPLMN-r16xy field that, if present indicates that the first cell in which the UE performed RRC connection setup after declaring RLF/HOF and failing to perform reestablishment belongs to a different PLMN than the plmn-IdentityList stored in VarRLF-Report.

In other embodiments, a UE can include reconnectCellID and time UntilReconnection fields in an RLF report only when the first cell in which the UE reconnected after the RLF and subsequent failed reestablishment belongs to a PLMN in plmn-IdentityList stored in the RLF report. Additionally, the UE can include an indicator in the RLF report when the reconnectCellID (included in the RLF report) is not the first cell in which the UE reconnected after the RLF and subsequent failed reestablishment.

These embodiments can be further illustrated by the following procedural text, which can be part of an NR RRC standard such as 3GPP TS 38.331 (v16.4.1). Note that this text may omit certain operations performed by the UE for the sake of brevity, and may be combined with existing text in 3GPP TS 38.331 (v16.4.1).

```
*** Begin 3GPP procedural text ***
The UE shall perform the following actions upon reception of the RRCSetup:
  . . .
  1>if the UE has radio link failure or handover failure information available in VarRLF-
    Report:
    2>if reconnectCellID in VarRLF-Report is not set and if
      firstReconnectionInDifferentPLMN in VarRLF-Report is not set:
      3>if the RPLMN is included in plmn-IdentityList stored in VarRLF-Report:
        4> set time UntilReconnection in VarRLF-Report to the time that elapsed since the
          last radio link failure or handover failure;
        4> set nrReconnectCellId in reconnectCellID in VarRLF-Report to the global cell
          identity and the tracking area code of the PCell;
      3> else:
        4>set firstReconnectionInDifferentPLMN in VarRLF-Report to true;
  1>if the UE supports RLF report for inter-RAT MRO NR as defined in TS 36.306 [62], and
    if the UE has radio link failure or handover failure information available in VarRLF-
    Report of TS 36.331 [10]:
    2>if reconnectCellID in VarRLF-Report of TS 36.331 [10] is not set and if
      firstReconnectionInDifferentPLMN in VarRLF-Report of TS 36.331 [10] is not set:
      3>if the RPLMN is included in plmn-IdentityList stored in VarRLF-Report of TS
      36.331 [10]:
      4>set time UntilReconnection in VarRLF-Report of TS 36.331[10] to the time that
      elapsed since the last radio link failure or handover failure in LTE;
      4> set nrReconnectCellId in reconnectCellID in VarRLF-Report of TS 36.331[10]
      to the global cell identity and the tracking area code of the PCell;
      3>else:
        4>set firstReconnectionInDifferentPLMN in VarRLF-Report of TS 36.331[10] to
          true;
        . . .
  1> submit the RRCSetupComplete message to lower layers for transmission, upon which the
  procedure ends.
*** End 3GPP procedural text ***
```

The exemplary UEInformationResponse message defined by the ASN.1 data structure shown in FIG. 12 (described previously) can be used with the above exemplary procedural text for NR RRC.

These embodiments can also be illustrated by the following procedural text, which can be part of an LTE RRC standard such as 3GPP TS 36.331 (v16.4.0). Note that this text may omit certain operations performed by the UE for the sake of brevity, and may be combined with existing text in 3GPP TS 36.331 (v16.4.0).

```
*** Begin 3GPP procedural text ***
The UE shall [upon reception of RRCConnectionSetup]:
  . . .
  1>except for NB-IoT:
    2>if the UE supports RLF report for inter-RAT MRO EUTRA as defined in TS 38.306
      [87], and if the UE has radio link failure or handover failure information available in
      VarRLF-Report of TS 38.331 [82]:
      3>if reconnectCellId in VarRLF-Report of TS 38.331 [82] is not set and if
        firstReconnectionInDifferentPLMN in VarRLF-Report of TS 38.331 [82] is not set:
        4>if the RPLMN is included in plmn-IdentityList stored in VarRLF-Report of TS
          38.331 [82]
          5> set time UntilReconnection in VarRLF-Report of TS 38.331 [82] to the time
          that elapsed since the last radio link failure or handover failure;
          5> set eutraReconnectCellId in reconnectCellId in VarRLF-Report of TS 38.331
          [82] to the global cell identity and the tracking area code of the PCell;
        4>else:
          5>set firstReconnectionInDifferentPLMN in VarRLF-Report of TS 38.331[82] to
            true;
    . . .
  1>set the content of RRCConnectionSetupComplete message as follows:
    2>if the UE is connected to EPC:
      3>except for NB-IoT:
        4>if the UE has radio link failure or handover failure information available in
          VarRLF-Report:
        4> if this is the first RRCSetup received by the UE after declaring RLF/HOF and if
          the RPLMN is not included in plmn-IdentityList stored in VarRLF-Report:
          5>if reconnectCellID in VarRLF-Report is not set and if
            firstReconnectionInDifferentPLMN in VarRLF-Report is not set:
            6>if the RPLMN is included in plmn-IdentityList stored in VarRLF-Report:
              7> set time UntilReconnection in VarRLF-Report to the time that elapsed
              since the last radio link failure or handover failure;
              7> set eutraReconnectCellId in reconnectCellID in VarRLF-Report to the
              global cell identity and the tracking area code of the PCell;
            6>else:
              7>set firstReconnectionInDifferentPLMN in VarRLF-Report to true;
          5> if the RPLMN is included in plmn-IdentityList stored in VarRLF-Report:
            6>  include rlf-InfoAvailable;
  . . .
  1>submit the RRCConnectionSetupComplete message to lower layers for transmission;
  1>the procedure ends.
*** End 3GPP procedural text ***
```

The exemplary UEInformationResponse message defined by the ASN.1 data structure shown in FIG. 13 (described previously) can be used with the above exemplary procedural text for LTE RRC.

In other embodiments, a UE can include time UntilReconnection in an RLF report regardless of whether the first cell in which the UE reconnected after the RLF and subsequent failed reestablishment belongs to a PLMN in plmn-IdentityList stored in the RLF report. Additionally, the UE can include an indicator in the RLF report when the reconnectCellID (included in the RLF report) is not the first cell in which the UE reconnected after the RLF and subsequent failed reestablishment. These embodiments have the advantage and/or benefit that the network node can determine, based on the contents RLF report, that the time UntilReconnection refers to the point in time when the UE reconnected to a cell not belonging to a PLMN in the plmn-IdentityList stored in the RLF report.

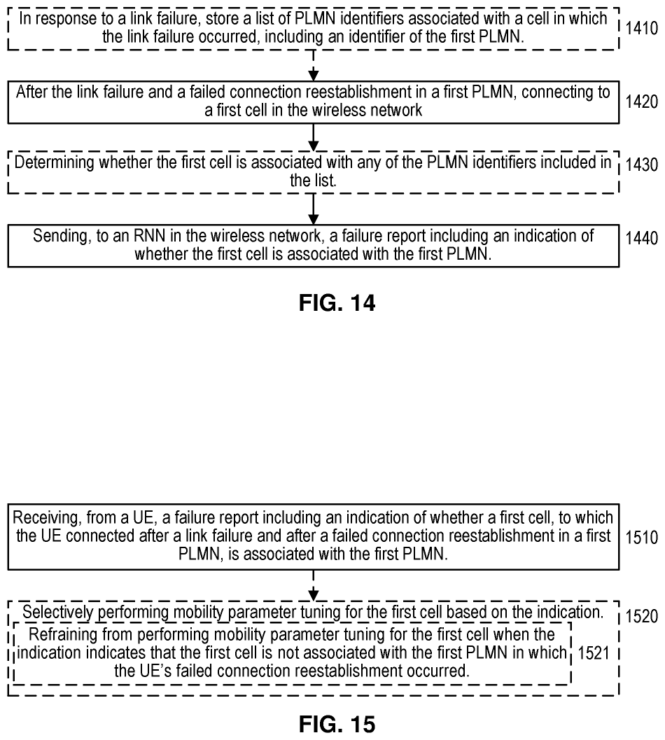

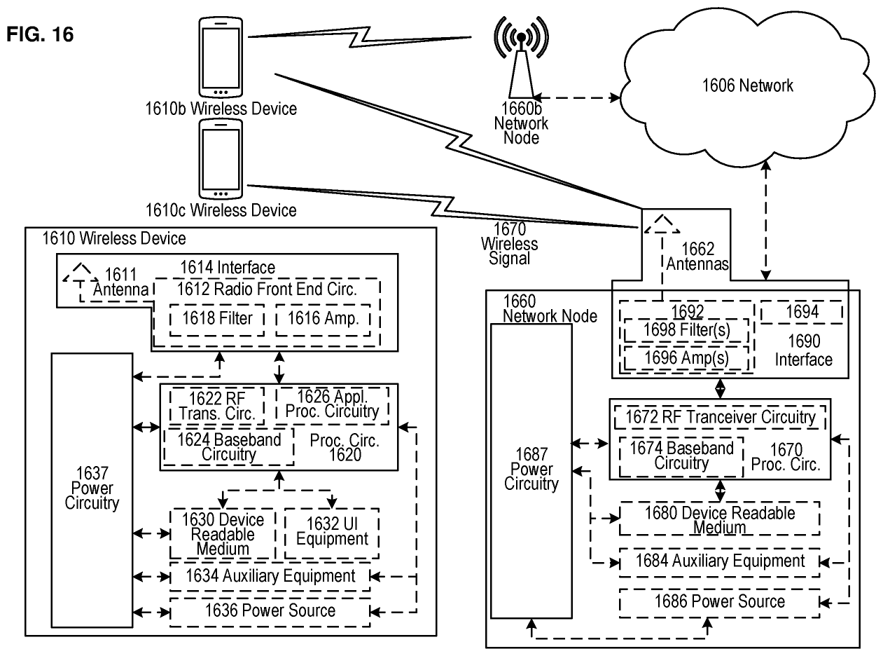

The embodiments described above can be further illustrated with reference to FIGS. 14-15, which show exemplary methods (e.g., procedures) for a UE and a RAN node (RNN), respectively. In other words, various features of operations described below correspond to various embodiments described above. These exemplary methods can be used cooperatively to provide various exemplary benefits and/or advantages. Although FIGS. 14-15 show specific blocks in a particular order, the operations of the respective methods can be performed in different orders than shown and can be combined and/or divided into blocks having different functionality than shown. Optional blocks or operations are indicated by dashed lines.

In particular, FIG. 14 shows a flow diagram of an exemplary method (e.g., procedure) for a UE to report link failures in a wireless network, according to various embodiments of the present disclosure. The exemplary method can be performed by a UE (e.g., wireless device, IoT device, modem, etc. or component thereof) such as described elsewhere herein.

The exemplary method can include operations of block 1420, where the UE can, after a link failure and a failed connection reestablishment in a first PLMN, connect to a first cell in the wireless network. The exemplary method can also include operations of block 1440, where the UE can send, to an RNN in the wireless network, a failure report including an indication of whether the first cell is associated with the first PLMN.

In some embodiments, the link failure is an RLF or an HOF declared by the UE in the first PLMN, and the failure report is an RLF report. In some embodiments, the link failure occurred in a second cell associated with the first PLMN and the failed connection reestablishment occurred in a third cell associated with the first PLMN.

In some embodiments, the exemplary method can also include the operations of block 1410, where the UE can, in response to the link failure, store a list of PLMN identifiers associated with a cell in which the link failure occurred, including an identifier of the first PLMN. An example of such a list of identifiers is the plmn-IdentityList discussed above. In some of these embodiments, the list of PLMN identifiers is included in the failure report. In some of these embodiments, the RNN is part of at least one of the PLMNs identified in the list.

In some of these embodiments, the exemplary method can also include the operations of block 1430, where the UE can determine whether the first cell (e.g., in which the UE connected) is associated with any of the PLMN identifiers in the list. The indication can be based on the outcome of this determination, according to different variants discussed below.

In some variants, the indication comprises:
an identifier of the first cell, when the first cell is associated with at least one PLMN identifier included in the list; and
no identifier of the first cell, when the first cell is not associated with any of the PLMN identifiers included in the list.

In other variants, the indication comprises:
an identifier of the first cell, and
when the first cell is not associated with any of the PLMN identifiers included in the list, an indication that the UE first reconnected to the wireless network, after the link failure and the failed connection reestablishment, in a PLMN that is not identified in the list.

In other variants, the indication comprises:
when the first cell is associated with at least one PLMN identifier included in the list, an identifier of the first cell and a further indication of time elapsed between the link failure and connecting to the first cell; and
when the first cell is not associated with any of the PLMN identifiers included in the list, an indication that the UE first reconnected to the wireless network, after the link failure and the failed connection reestablishment, in a PLMN that is not identified in the list.

In other variants, the indication comprises:
a further indication of a time elapsed between the link failure and connecting to the first cell; and
when the first cell is not associated with any of the PLMN identifiers included in the list, an indication that the UE first reconnected to the wireless network, after the link failure and the failed connection reestablishment, in a PLMN that is not identified in the list.
   The ASN.1 data structures shown in FIGS. 12-13 can be used in conjunction with different ones of the variants described above.

In addition, FIG. 15 shows a flow diagram of an exemplary method (e.g., procedure) for a radio network node (RNN) in a wireless network to receive failure reports from UEs, according to various embodiments of the present disclosure. The exemplary method can be performed by an RNN (e.g., base station, eNB, gNB, ng-eNB, en-gNB, etc., or components thereof) such as described elsewhere herein.

The exemplary method can include operations of block 1510, where the RNN can receive, from a UE, a failure report including an indication of whether a first cell, to which the UE connected after a link failure and after a failed connection reestablishment in a first PLMN, is associated with the first PLMN.

In some embodiments, the link failure is an RLF or an HOF declared by the UE in the first PLMN, and the failure report is an RLF report. In some embodiments, the failure report includes a list of PLMN identifiers associated with a cell in which the link failure occurred, including an identifier of the first PLMN. An example of such a list of identifiers is the plmn-IdentityList discussed above. In some of these embodiments, the RNN is part of at least one of the PLMNs identified in the list. In some embodiments, the link failure occurred in a second cell associated with the first PLMN and the failed connection reestablishment occurred in a third cell associated with the first PLMN.

In different variants, the indication can have any of the forms and/or contents discussed above in relation to the UE embodiments of FIG. 14. As mentioned above, the ASN.1 data structures shown in FIGS. 12-13 can be used in conjunction with different ones of these variants.

In some embodiments, the exemplary method can also include the operations of block 1520, where the RNN can selectively perform mobility parameter tuning for the first cell based on the indication. For example, these operations can be part of SON functionality, which is described in more detail above. In some embodiments, the selectively performing operations of block 1520 can include the operations of sub-block 1521, where the RNN can refrain from performing mobility parameter tuning for the first cell when the indication indicates that the first cell is not associated with the first PLMN in which the UE's failed connection reestablishment occurred.

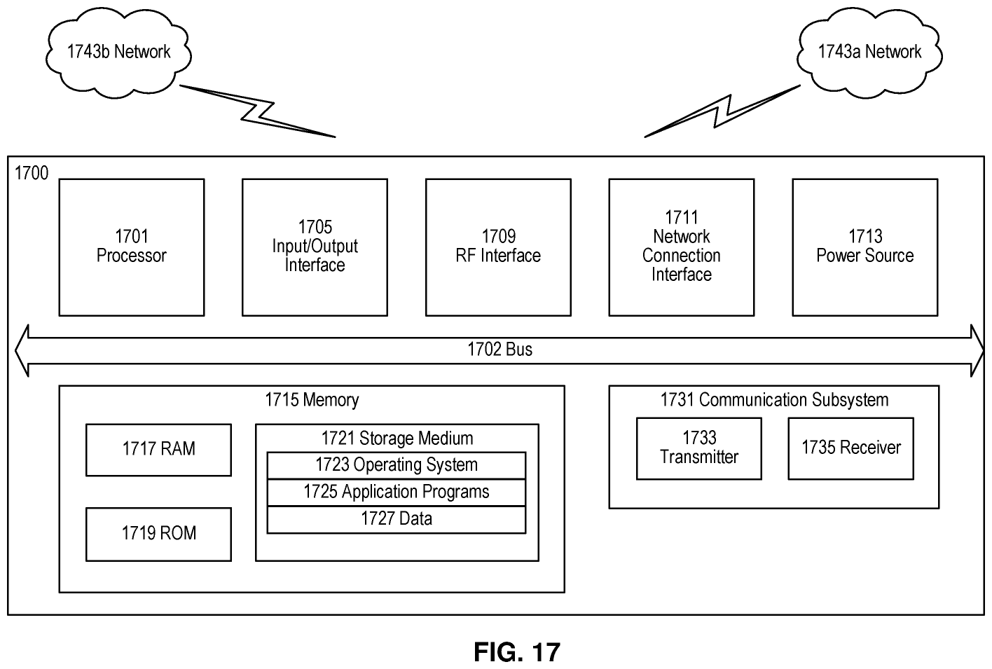

Although the subject matter described herein can be implemented in any appropriate type of system using any suitable components, the embodiments disclosed herein are described in relation to a wireless network, such as the example wireless network illustrated in FIG. 16. For simplicity, the wireless network of FIG. 16 only depicts network 1606, network nodes 1660 and 1660b, and WDs 1610, 1610b, and 1610c. In practice, a wireless network can further include any additional elements suitable to support communication between wireless devices or between a wireless device and another communication device, such as a landline telephone, a service provider, or any other network node or end device. Of the illustrated components, network node 1660 and wireless device (WD) 1610 are depicted with additional detail. The wireless network can provide communication and other types of services to one or more wireless devices to facilitate the wireless devices' access to and/or use of the services provided by, or via, the wireless network.

The wireless network can comprise and/or interface with any type of communication, telecommunication, data, cellular, and/or radio network or other similar type of system. In some embodiments, the wireless network can be configured to operate according to specific standards or other types of predefined rules or procedures. Thus, particular embodiments of the wireless network can implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1606 can comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1660 and WD 1610 comprise various components described in more detail below. These components work together in order to provide network node and/or wireless device functionality, such as providing wireless connections in a wireless network. In different embodiments, the wireless network can comprise any number of wired or wireless networks, network nodes, base stations, controllers, wireless devices, relay stations, and/or any other components or systems that can facilitate or participate in the communication of data and/or signals whether via wired or wireless connections.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations can be categorized based on the amount of coverage they provide (or, stated differently, their transmit power level) and can then also be referred to as femto base stations, pico base stations, micro base stations, or macro base stations. A base station can be a relay node or a relay donor node controlling a relay. A network node can also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station can also be referred to as nodes in a distributed antenna system (DAS).

Further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node can be a virtual network node as described in more detail below. More generally, however, network nodes can represent any suitable device (or group of devices) capable, configured, arranged, and/or operable to enable and/or provide a wireless device with access to the wireless network or to provide some service to a wireless device that has accessed the wireless network.

In FIG. 16, network node 1660 includes processing circuitry 1670, device readable medium 1680, interface 1690, auxiliary equipment 1684, power source 1686, power circuitry 1687, and antenna 1662. Although network node 1660 illustrated in the example wireless network of FIG. 16 can represent a device that includes the illustrated combination of hardware components, other embodiments can comprise network nodes with different combinations of components. It is to be understood that a network node comprises any suitable combination of hardware and/or software needed to perform the tasks, features, functions and methods and/or procedures disclosed herein. Moreover, while the components of network node 1660 are depicted as single boxes located within a larger box, or nested within multiple boxes, in practice, a network node can comprise multiple different physical components that make up a single illustrated component (e.g., device readable medium 1680 can comprise multiple separate hard drives as well as multiple RAM modules).

Similarly, network node 1660 can be composed of multiple physically separate components (e.g., a NodeB component and a RNC component, or a BTS component and a BSC component, etc.), which can each have their own respective components. In certain scenarios in which network node 1660 comprises multiple separate components (e.g., BTS and BSC components), one or more of the separate components can be shared among several network nodes. For example, a single RNC can control multiple NodeB's. In such a scenario, each unique NodeB and RNC pair, can in some instances be considered a single separate network node. In some embodiments, network node 1660 can be configured to support multiple radio access technologies (RATs). In such embodiments, some components can be duplicated (e.g., separate device readable medium 1680 for the different RATs) and some components can be reused (e.g., the same antenna 1662 can be shared by the RATs). Network node 1660 can also include multiple sets of the various illustrated components for different wireless technologies integrated into network node 1660, such as, for example, GSM, WCDMA, LTE, NR, WiFi, or Bluetooth wireless technologies. These wireless technologies can be integrated into the same or different chip or set of chips and other components within network node 1660.

Processing circuitry 1670 can be configured to perform any determining, calculating, or similar operations (e.g., certain obtaining operations) described herein as being provided by a network node. These operations performed by processing circuitry 1670 can include processing information obtained by processing circuitry 1670 by, for example, converting the obtained information into other information, comparing the obtained information or converted information to information stored in the network node, and/or performing one or more operations based on the obtained information or converted information, and as a result of said processing making a determination.

Processing circuitry 1670 can comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide various functionality of network node 1660, either alone or in conjunction with other network node 1660 components (e.g., device readable medium 1680). Such functionality can include any of the various wireless features, functions, or benefits discussed herein.

For example, processing circuitry 1670 can execute instructions stored in device readable medium 1680 or in memory within processing circuitry 1670. In some embodiments, processing circuitry 1670 can include a system on a chip (SOC). As a more specific example, instructions (also referred to as a computer program product) stored in medium 1680 can include instructions that, when executed by processing circuitry 1670, can configure network node 1660 to perform operations corresponding to various exemplary methods (e.g., procedures) described herein.

In some embodiments, processing circuitry 1670 can include one or more of radio frequency (RF) transceiver circuitry 1672 and baseband processing circuitry 1674. In some embodiments, radio frequency (RF) transceiver circuitry 1672 and baseband processing circuitry 1674 can be on separate chips (or sets of chips), boards, or units, such as radio units and digital units. In alternative embodiments, part or all of RF transceiver circuitry 1672 and baseband processing circuitry 1674 can be on the same chip or set of chips, boards, or units.

In certain embodiments, some or all of the functionality described herein as being provided by a network node, base station, eNB or other such network device can be performed by processing circuitry 1670 executing instructions stored on device readable medium 1680 or memory within processing circuitry 1670. In alternative embodiments, some or all of the functionality can be provided by processing circuitry 1670 without executing instructions stored on a separate or discrete device readable medium, such as in a hard-wired manner. In any of those embodiments, whether executing instructions stored on a device readable storage medium or not, processing circuitry 1670 can be configured to perform the described functionality. The benefits provided by such functionality are not limited to processing circuitry 1670 alone or to other components of network node 1660 but are enjoyed by network node 1660 as a whole, and/or by end users and the wireless network generally.

Device readable medium 1680 can comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that can be used by processing circuitry 1670. Device readable medium 1680 can store any suitable instructions, data or information, including a computer program, software, an application including one or more of logic, rules, code, tables, etc. and/or other instructions capable of being executed by processing circuitry 1670 and, utilized by network node 1660. Device readable medium 1680 can be used to store any calculations made by processing circuitry 1670 and/or any data received via interface 1690. In some embodiments, processing circuitry 1670 and device readable medium 1680 can be considered to be integrated.

Interface 1690 is used in the wired or wireless communication of signaling and/or data between network node 1660, network 1606, and/or WDs 1610. As illustrated, interface 1690 comprises port(s)/terminal(s) 1694 to send and receive data, for example to and from network 1606 over a wired connection. Interface 1690 also includes radio front end circuitry 1692 that can be coupled to, or in certain embodiments a part of, antenna 1662. Radio front end circuitry 1692 comprises filters 1698 and amplifiers 1696. Radio front end circuitry 1692 can be connected to antenna 1662 and processing circuitry 1670. Radio front end circuitry can be configured to condition signals communicated between antenna 1662 and processing circuitry 1670. Radio front end circuitry 1692 can receive digital data that is to be sent out to other network nodes or WDs via a wireless connection. Radio front end circuitry 1692 can convert the digital data into a radio signal having the appropriate channel and bandwidth parameters using a combination of filters 1698 and/or amplifiers 1696. The radio signal can then be transmitted via antenna 1662. Similarly, when receiving data, antenna 1662 can collect radio signals which are then converted into digital data by radio front end circuitry 1692. The digital data can be passed to processing circuitry 1670. In other embodiments, the interface can comprise different components and/or different combinations of components.

In certain alternative embodiments, network node 1660 may not include separate radio front end circuitry 1692, instead, processing circuitry 1670 can comprise radio front end circuitry and can be connected to antenna 1662 without separate radio front end circuitry 1692. Similarly, in some embodiments, all or some of RF transceiver circuitry 1672 can be considered a part of interface 1690. In still other embodiments, interface 1690 can include one or more ports or terminals 1694, radio front end circuitry 1692, and RF transceiver circuitry 1672, as part of a radio unit (not shown), and interface 1690 can communicate with baseband processing circuitry 1674, which is part of a digital unit (not shown).

Antenna 1662 can include one or more antennas, or antenna arrays, configured to send and/or receive wireless signals. Antenna 1662 can be coupled to radio front end circuitry 1690 and can be any type of antenna capable of transmitting and receiving data and/or signals wirelessly. In some embodiments, antenna 1662 can comprise one or more omni-directional, sector or panel antennas operable to transmit/receive radio signals between, for example, 2 GHz and 66 GHz. An omni-directional antenna can be used to transmit/receive radio signals in any direction, a sector antenna can be used to transmit/receive radio signals from devices within a particular area, and a panel antenna can be a line of sight antenna used to transmit/receive radio signals in a relatively straight line. In some instances, the use of more than one antenna can be referred to as MIMO. In certain embodiments, antenna 1662 can be separate from network node 1660 and can be connectable to network node 1660 through an interface or port.

Antenna 1662, interface 1690, and/or processing circuitry 1670 can be configured to perform any receiving operations and/or certain obtaining operations described herein as being performed by a network node. Any information, data and/or signals can be received from a wireless device, another network node and/or any other network equipment. Similarly, antenna 1662, interface 1690, and/or processing circuitry 1670 can be configured to perform any transmitting operations described herein as being performed by a network node. Any information, data and/or signals can be transmitted to a wireless device, another network node and/or any other network equipment.

Power circuitry 1687 can comprise, or be coupled to, power management circuitry and can be configured to supply the components of network node 1660 with power for performing the functionality described herein. Power circuitry 1687 can receive power from power source 1686. Power source 1686 and/or power circuitry 1687 can be configured to provide power to the various components of network node 1660 in a form suitable for the respective components (e.g., at a voltage and current level needed for each respective component). Power source 1686 can either be included in, or external to, power circuitry 1687 and/or network node 1660. For example, network node 1660 can be connectable to an external power source (e.g., an electricity outlet) via an input circuitry or interface such as an electrical cable, whereby the external power source supplies power to power circuitry 1687. As a further example, power source 1686 can comprise a source of power in the form of a battery or battery pack which is connected to, or integrated in, power circuitry 1687. The battery can provide backup power should the external power source fail. Other types of power sources, such as photovoltaic devices, can also be used.

Alternative embodiments of network node 1660 can include additional components beyond those shown in FIG. 16 that can be responsible for providing certain aspects of the network node's functionality, including any of the functionality described herein and/or any functionality necessary to support the subject matter described herein. For example, network node 1660 can include user interface equipment to allow and/or facilitate input of information into network node 1660 and to allow and/or facilitate output of information from network node 1660. This can allow and/or facilitate a user to perform diagnostic, maintenance, repair, and other administrative functions for network node 1660.

In some embodiments, a wireless device (WD, e.g., WD 1610) can be configured to transmit and/or receive information without direct human interaction. For instance, a WD can be designed to transmit information to a network on a predetermined schedule, when triggered by an internal or external event, or in response to requests from the network. Examples of a WD include, but are not limited to, smart phones, mobile phones, cell phones, voice over IP (VoIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc.

A WD can support device-to-device (D2D) communication, for example by implementing a 3GPP standard for sidelink communication, vehicle-to-vehicle (V2V), vehicle-to-infrastructure (V2I), vehicle-to-everything (V2X) and can in this case be referred to as a D2D communication device. As yet another specific example, in an Internet of Things (IoT) scenario, a WD can represent a machine or other device that performs monitoring and/or measurements and transmits the results of such monitoring and/or measurements to another WD and/or a network node. The WD can in this case be a machine-to-machine (M2M) device, which can in a 3GPP context be referred to as an MTC device. As one particular example, the WD can be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a WD can represent a vehicle or other equipment that is capable of monitoring and/or reporting on its operational status or other functions associated with its operation. A WD as described above can represent the endpoint of a wireless connection, in which case the device can be referred to as a wireless terminal. Furthermore, a WD as described above can be mobile, in which case it can also be referred to as a mobile device or a mobile terminal.

As illustrated, wireless device 1610 includes antenna 1611, interface 1614, processing circuitry 1620, device readable medium 1630, user interface equipment 1632, auxiliary equipment 1634, power source 1636 and power circuitry 1637. WD 1610 can include multiple sets of one or more of the illustrated components for different wireless technologies supported by WD 1610, such as, for example, GSM, WCDMA, LTE, NR, WiFi, WiMAX, or Bluetooth wireless technologies, just to mention a few. These wireless technologies can be integrated into the same or different chips or set of chips as other components within WD 1610.

Antenna 1611 can include one or more antennas or antenna arrays, configured to send and/or receive wireless signals, and is connected to interface 1614. In certain alternative embodiments, antenna 1611 can be separate from WD 1610 and be connectable to WD 1610 through an interface or port. Antenna 1611, interface 1614, and/or processing circuitry 1620 can be configured to perform any receiving or transmitting operations described herein as being performed by a WD. Any information, data and/or signals can be received from a network node and/or another WD. In some embodiments, radio front end circuitry and/or antenna 1611 can be considered an interface.

As illustrated, interface 1614 comprises radio front end circuitry 1612 and antenna 1611. Radio front end circuitry 1612 comprise one or more filters 1618 and amplifiers 1616. Radio front end circuitry 1614 is connected to antenna 1611 and processing circuitry 1620 and can be configured to condition signals communicated between antenna 1611 and processing circuitry 1620. Radio front end circuitry 1612 can be coupled to or a part of antenna 1611. In some embodiments, WD 1610 may not include separate radio front end circuitry 1612; rather, processing circuitry 1620 can comprise radio front end circuitry and can be connected to antenna 1611. Similarly, in some embodiments, some or all of RF transceiver circuitry 1622 can be considered a part of interface 1614. Radio front end circuitry 1612 can receive digital data that is to be sent out to other network nodes or WDs via a wireless connection. Radio front end circuitry 1612 can convert the digital data into a radio signal having the appropriate channel and bandwidth parameters using a combination of filters 1618 and/or amplifiers 1616. The radio signal can then be transmitted via antenna 1611. Similarly, when receiving data, antenna 1611 can collect radio signals which are then converted into digital data by radio front end circuitry 1612. The digital data can be passed to processing circuitry 1620. In other embodiments, the interface can comprise different components and/or different combinations of components.

Processing circuitry 1620 can comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide WD 1610 functionality either alone or in combination with other WD 1610 components, such as device readable medium 1630. Such functionality can include any of the various wireless features or benefits discussed herein.

For example, processing circuitry 1620 can execute instructions stored in device readable medium 1630 or in memory within processing circuitry 1620 to provide the functionality disclosed herein. More specifically, instructions (also referred to as a computer program product) stored in medium 1630 can include instructions that, when executed by processor 1620, can configure wireless device 1610 to perform operations corresponding to various exemplary methods (e.g., procedures) described herein.

As illustrated, processing circuitry 1620 includes one or more of RF transceiver circuitry 1622, baseband processing circuitry 1624, and application processing circuitry 1626. In other embodiments, the processing circuitry can comprise different components and/or different combinations of components. In certain embodiments processing circuitry 1620 of WD 1610 can comprise a SOC. In some embodiments, RF transceiver circuitry 1622, baseband processing circuitry 1624, and application processing circuitry 1626 can be on separate chips or sets of chips. In alternative embodiments, part or all of baseband processing circuitry 1624 and application processing circuitry 1626 can be combined into one chip or set of chips, and RF transceiver circuitry 1622 can be on a separate chip or set of chips. In still alternative embodiments, part or all of RF transceiver circuitry 1622 and baseband processing circuitry 1624 can be on the same chip or set of chips, and application processing circuitry 1626 can be on a separate chip or set of chips. In yet other alternative embodiments, part or all of RF transceiver circuitry 1622, baseband processing circuitry 1624, and application processing circuitry 1626 can be combined in the same chip or set of chips. In some embodiments, RF transceiver circuitry 1622 can be a part of interface 1614. RF transceiver circuitry 1622 can condition RF signals for processing circuitry 1620.

In certain embodiments, some or all of the functionality described herein as being performed by a WD can be provided by processing circuitry 1620 executing instructions stored on device readable medium 1630, which in certain embodiments can be a computer-readable storage medium. In alternative embodiments, some or all of the functionality can be provided by processing circuitry 1620 without executing instructions stored on a separate or discrete device readable storage medium, such as in a hard-wired manner. In any of those particular embodiments, whether executing instructions stored on a device readable storage medium or not, processing circuitry 1620 can be configured to perform the described functionality. The benefits provided by such functionality are not limited to processing circuitry 1620 alone or to other components of WD 1610, but are enjoyed by WD 1610 as a whole, and/or by end users and the wireless network generally.

Processing circuitry 1620 can be configured to perform any determining, calculating, or similar operations (e.g., certain obtaining operations) described herein as being performed by a WD. These operations, as performed by processing circuitry 1620, can include processing information obtained by processing circuitry 1620 by, for example, converting the obtained information into other information, comparing the obtained information or converted information to information stored by WD 1610, and/or performing one or more operations based on the obtained information or converted information, and as a result of said processing making a determination.

Device readable medium 1630 can be operable to store a computer program, software, an application including one or more of logic, rules, code, tables, etc. and/or other instructions capable of being executed by processing circuitry 1620. Device readable medium 1630 can include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that can be used by processing circuitry 1620. In some embodiments, processing circuitry 1620 and device readable medium 1630 can be considered to be integrated.

User interface equipment 1632 can include components that allow and/or facilitate a human user to interact with WD 1610. Such interaction can be of many forms, such as visual, audial, tactile, etc. User interface equipment 1632 can be operable to produce output to the user and to allow and/or facilitate the user to provide input to WD 1610. The type of interaction can vary depending on the type of user interface equipment 1632 installed in WD 1610. For example, if WD 1610 is a smart phone, the interaction can be via a touch screen; if WD 1610 is a smart meter, the interaction can be through a screen that provides usage (e.g., the number of gallons used) or a speaker that provides an audible alert (e.g., if smoke is detected). User interface equipment 1632 can include input interfaces, devices and circuits, and output interfaces, devices and circuits. User interface equipment 1632 can be configured to allow and/or facilitate input of information into WD 1610 and is connected to processing circuitry 1620 to allow and/or facilitate processing circuitry 1620 to process the input information. User interface equipment 1632 can include, for example, a microphone, a proximity or other sensor, keys/buttons, a touch display, one or more cameras, a USB port, or other input circuitry. User interface equipment 1632 is also configured to allow and/or facilitate output of information from WD 1610, and to allow and/or facilitate processing circuitry 1620 to output information from WD 1610. User interface equipment 1632 can include, for example, a speaker, a display, vibrating circuitry, a USB port, a headphone interface, or other output circuitry. Using one or more input and output interfaces, devices, and circuits, of user interface equipment 1632, WD 1610 can communicate with end users and/or the wireless network and allow and/or facilitate them to benefit from the functionality described herein.

Auxiliary equipment 1634 is operable to provide more specific functionality which may not be generally performed by WDs. This can comprise specialized sensors for doing measurements for various purposes, interfaces for additional types of communication such as wired communications etc. The inclusion and type of components of auxiliary equipment 1634 can vary depending on the embodiment and/or scenario.

Power source 1636 can, in some embodiments, be in the form of a battery or battery pack. Other types of power sources, such as an external power source (e.g., an electricity outlet), photovoltaic devices or power cells, can also be used. WD 1610 can further comprise power circuitry 1637 for delivering power from power source 1636 to the various parts of WD 1610 which need power from power source 1636 to carry out any functionality described or indicated herein. Power circuitry 1637 can in certain embodiments comprise power management circuitry. Power circuitry 1637 can additionally or alternatively be operable to receive power from an external power source; in which case WD 1610 can be connectable to the external power source (such as an electricity outlet) via input circuitry or an interface such as an electrical power cable. Power circuitry 1637 can also in certain embodiments be operable to deliver power from an external power source to power source 1636. This can be, for example, for the charging of power source 1636. Power circuitry 1637 can perform any converting or other modification to the power from power source 1636 to make it suitable for supply to the respective components of WD 1610.

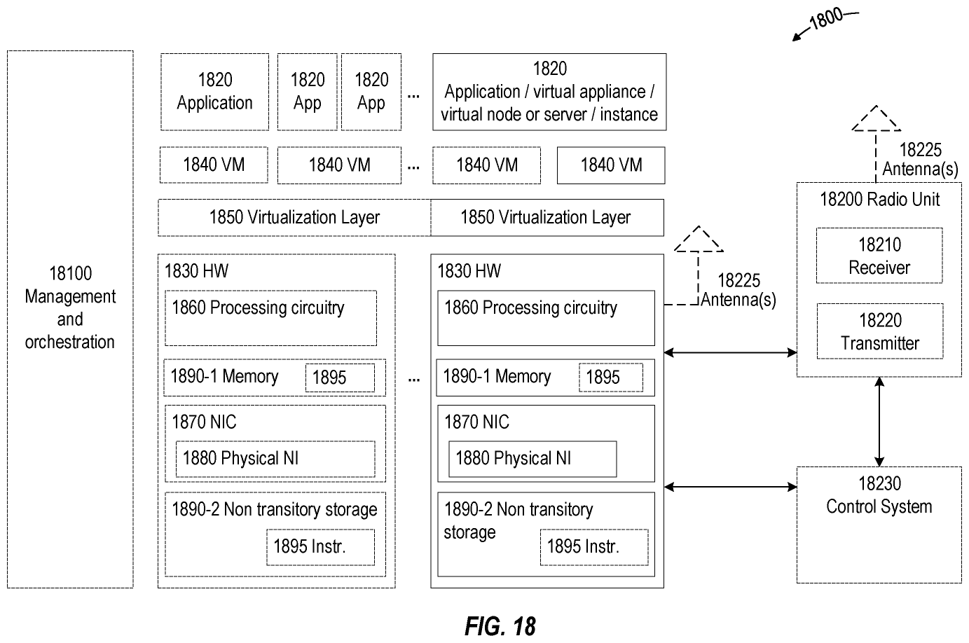

FIG. 17 illustrates one embodiment of a UE in accordance with various aspects described herein. As used herein, a user equipment or UE may not necessarily have a user in the sense of a human user who owns and/or operates the relevant device. Instead, a UE can represent a device that is intended for sale to, or operation by, a human user but which may not, or which may not initially, be associated with a specific human user (e.g., a smart sprinkler controller). Alternatively, a UE can represent a device that is not intended for sale to, or operation by, an end user but which can be associated with or operated for the benefit of a user (e.g., a smart power meter). UE 17200 can be any UE identified by the 3^{rd} Generation Partnership Project (3GPP), including a NB-IoT UE, a machine type communication (MTC) UE, and/or an enhanced MTC (eMTC) UE. UE 1700, as illustrated in FIG. 17, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE can be used interchangeable. Accordingly, although FIG. 17 is a UE, the components discussed herein are equally applicable to a WD, and vice-versa.

In FIG. 17, UE 1700 includes processing circuitry 1701 that is operatively coupled to input/output interface 1705, radio frequency (RF) interface 1709, network connection interface 1711, memory 1715 including random access memory (RAM) 1717, read-only memory (ROM) 1719, and storage medium 1721 or the like, communication subsystem 1731, power source 1733, and/or any other component, or any combination thereof. Storage medium 1721 includes operating system 1723, application program 1725, and data 1727. In other embodiments, storage medium 1721 can include other similar types of information. Certain UEs can utilize all of the components shown in FIG. 17, or only a subset of the components. The level of integration between the components can vary from one UE to another UE. Further, certain UEs can contain multiple instances of a component, such as multiple processors, memories, transceivers, transmitters, receivers, etc.

In FIG. 17, processing circuitry 1701 can be configured to process computer instructions and data. Processing circuitry 1701 can be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1701 can include two central processing units (CPUs). Data can be information in a form suitable for use by a computer.

In the depicted embodiment, input/output interface 1705 can be configured to provide a communication interface to an input device, output device, or input and output device. UE 1700 can be configured to use an output device via input/output interface 1705. An output device can use the same type of interface port as an input device. For example, a USB port can be used to provide input to and output from UE 1700. The output device can be a speaker, a sound card, a video card, a display, a monitor, a printer, an actuator, an emitter, a smartcard, another output device, or any combination thereof. UE 1700 can be configured to use an input device via input/output interface 1705 to allow and/or facilitate a user to capture information into UE 1700. The input device can include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display can include a capacitive or resistive touch sensor to sense input from a user. A sensor can be, for instance, an accelerometer, a gyroscope, a tilt sensor, a force sensor, a magnetometer, an optical sensor, a proximity sensor, another like sensor, or any combination thereof. For example, the input device can be an accelerometer, a magnetometer, a digital camera, a microphone, and an optical sensor.

In FIG. 17, RF interface 1709 can be configured to provide a communication interface to RF components such as a transmitter, a receiver, and an antenna. Network connection interface 1711 can be configured to provide a communication interface to network 1743a. Network 1743a can encompass wired and/or wireless networks such as a local-area network (LAN), a wide-area network (WAN), a computer network, a wireless network, a telecommunications network, another like network or any combination thereof. For example, network 1743a can comprise a Wi-Fi network. Network connection interface 1711 can be configured to include a receiver and a transmitter interface used to communicate with one or more other devices over a communication network according to one or more communication protocols, such as Ethernet, TCP/IP, SONET, ATM, or the like. Network connection interface 1711 can implement receiver and transmitter functionality appropriate to the communication network links (e.g., optical, electrical, and the like). The transmitter and receiver functions can share circuit components, software or firmware, or alternatively can be implemented separately.

RAM 1717 can be configured to interface via bus 1702 to processing circuitry 1701 to provide storage or caching of data or computer instructions during the execution of software programs such as the operating system, application programs, and device drivers. ROM 1719 can be configured to provide computer instructions or data to processing circuitry 1701. For example, ROM 1719 can be configured to store invariant low-level system code or data for basic system functions such as basic input and output (I/O), startup, or reception of keystrokes from a keyboard that are stored in a non-volatile memory. Storage medium 1721 can be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives.

In one example, storage medium 1721 can be configured to include operating system 1723; application program 1725 such as a web browser application, a widget or gadget engine or another application; and data file 1727. Storage medium 1721 can store, for use by UE 1700, any of a variety of various operating systems or combinations of operating systems. For example, application program 1725 can include executable program instructions (also referred to as a computer program product) that, when executed by processor 1701, can configure UE 1700 to perform operations corresponding to various exemplary methods (e.g., procedures) described herein.

Storage medium 1721 can be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1721 can allow and/or facilitate UE 1700 to access computer-executable instructions, application programs or the like, stored on transitory or non-transitory memory media, to off-load data, or to upload data. An article of manufacture, such as one utilizing a communication system can be tangibly embodied in storage medium 1721, which can comprise a device readable medium.

In FIG. 17, processing circuitry 1701 can be configured to communicate with network 1743b using communication subsystem 1731. Network 1743a and network 1743b can be the same network or networks or different network or networks. Communication subsystem 1731 can be configured to include one or more transceivers used to communicate with network 1743b. For example, communication subsystem 1731 can be configured to include one or more transceivers used to communicate with one or more remote transceivers of another device capable of wireless communication such as another WD, UE, or base station of a radio access network (RAN) according to one or more communication protocols, such as IEEE 802.17, CDMA, WCDMA, GSM, LTE, UTRAN, WiMax, or the like. Each transceiver can include transmitter 1733 and/or receiver 1735 to implement transmitter or receiver functionality, respectively, appropriate to the RAN links (e.g., frequency allocations and the like). Further, transmitter 1733 and receiver 1735 of each transceiver can share circuit components, software or firmware, or alternatively can be implemented separately.

In the illustrated embodiment, the communication functions of communication subsystem 1731 can include data communication, voice communication, multimedia communication, short-range communications such as Bluetooth, near-field communication, location-based communication such as the use of the global positioning system (GPS) to determine a location, another like communication function, or any combination thereof. For example, communication subsystem 1731 can include cellular communication, Wi-Fi communication, Bluetooth communication, and GPS communication. Network 1743b can encompass wired and/or wireless networks such as a local-area network (LAN), a wide-area network (WAN), a computer network, a wireless network, a telecommunications network, another like network or any combination thereof. For example, network 1743b can be a cellular network, a Wi-Fi network, and/or a near-field network. Power source 1713 can be configured to provide alternating current (AC) or direct current (DC) power to components of UE 1700.

The features, benefits and/or functions described herein can be implemented in one of the components of UE 1700 or partitioned across multiple components of UE 1700. Further, the features, benefits, and/or functions described herein can be implemented in any combination of hardware, software or firmware. In one example, communication subsystem 1731 can be configured to include any of the components described herein. Further, processing circuitry 1701 can be configured to communicate with any of such components over bus 1702. In another example, any of such components can be represented by program instructions stored in memory that when executed by processing circuitry 1701 perform the corresponding functions described herein. In another example, the functionality of any of such components can be partitioned between processing circuitry 1701 and communication subsystem 1731. In another example, the non-computationally intensive functions of any of such components can be implemented in software or firmware and the computationally intensive functions can be implemented in hardware.

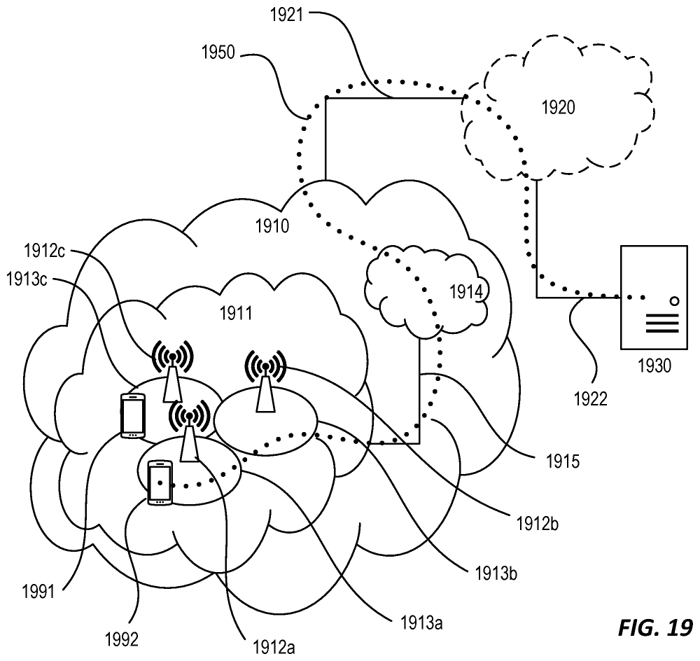

FIG. 18 is a schematic block diagram illustrating a virtualization environment 1800 in which functions implemented by some embodiments can be virtualized. In the present context, virtualizing means creating virtual versions of apparatuses or devices which can include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein can be implemented as virtual components executed by one or more virtual machines implemented in one or more virtual environments 1800 hosted by one or more of hardware nodes 1830. Further, in embodiments in which the virtual node is not a radio access node or does not require radio connectivity (e.g., a core network node), then the network node can be entirely virtualized.

The functions can be implemented by one or more applications 1820 (which can alternatively be called software instances, virtual appliances, network functions, virtual nodes, virtual network functions, etc.) operative to implement some of the features, functions, and/or benefits of some of the embodiments disclosed herein. Applications 1820 are run in virtualization environment 1800 which provides hardware 1830 comprising processing circuitry 1860 and memory 1890. Memory 1890 contains instructions 1895 executable by processing circuitry 1860 whereby application 1820 is operative to provide one or more of the features, benefits, and/or functions disclosed herein.

Virtualization environment 1800 can include general-purpose or special-purpose network hardware devices (or nodes) 1830 comprising a set of one or more processors or processing circuitry 1860, which can be commercial off-the-shelf (COTS) processors, dedicated Application Specific Integrated Circuits (ASICs), or any other type of processing circuitry including digital or analog hardware components or special purpose processors. Each hardware device can comprise memory 1890-1 which can be non-persistent memory for temporarily storing instructions 1895 or software executed by processing circuitry 1860. For example, instructions 1895 can include program instructions (also referred to as a computer program product) that, when executed by processing circuitry 1860, can configure hardware node 1820 to perform operations corresponding to various exemplary methods (e.g., procedures) described herein. Such operations can also be attributed to virtual node(s) 1820 that is/are hosted by hardware node 1830.

Each hardware device can comprise one or more network interface controllers (NICs) 1870, also known as network interface cards, which include physical network interface 1880. Each hardware device can also include non-transitory, persistent, machine-readable storage media 1890-2 having stored therein software 1895 and/or instructions executable by processing circuitry 1860. Software 1895 can include any type of software including software for instantiating one or more virtualization layers 1850 (also referred to as hypervisors), software to execute virtual machines 1840 as well as software allowing it to execute functions, features and/or benefits described in relation with some embodiments described herein.

Virtual machines 1840, comprise virtual processing, virtual memory, virtual networking or interface and virtual storage, and can be run by a corresponding virtualization layer 1850 or hypervisor. Different embodiments of the instance of virtual appliance 1820 can be implemented on one or more of virtual machines 1840, and the implementations can be made in different ways.

During operation, processing circuitry 1860 executes software 1895 to instantiate the hypervisor or virtualization layer 1850, which can sometimes be referred to as a virtual machine monitor (VMM). Virtualization layer 1850 can present a virtual operating platform that appears like networking hardware to virtual machine 1840.

As shown in FIG. 18, hardware 1830 can be a standalone network node with generic or specific components. Hardware 1830 can comprise antenna 18225 and can implement some functions via virtualization. Alternatively, hardware 1830 can be part of a larger cluster of hardware (e.g., such as in a data center or customer premise equipment (CPE)) where many hardware nodes work together and are managed via management and orchestration (MANO) 18100, which, among others, oversees lifecycle management of applications 1820.

Virtualization of the hardware is in some contexts referred to as network function virtualization (NFV). NFV can be used to consolidate many network equipment types onto industry standard high-volume server hardware, physical switches, and physical storage, which can be located in data centers, and customer premise equipment.

In the context of NFV, virtual machine 1840 can be a software implementation of a physical machine that runs programs as if they were executing on a physical, non-virtualized machine. Each of virtual machines 1840, and that part of hardware 1830 that executes that virtual machine, be it hardware dedicated to that virtual machine and/or hardware shared by that virtual machine with others of the virtual machines 1840, forms a separate virtual network elements (VNE).

Still in the context of NFV, Virtual Network Function (VNF) is responsible for handling specific network functions that run in one or more virtual machines 1840 on top of hardware networking infrastructure 1830 and corresponds to application 1820 in FIG. 18.

In some embodiments, one or more radio units 18200 that each include one or more transmitters 18220 and one or more receivers 18210 can be coupled to one or more antennas 18225. Radio units 18200 can communicate directly with hardware nodes 1830 via one or more appropriate network interfaces and can be used in combination with the virtual components to provide a virtual node with radio capabilities, such as a radio access node or a base station. Nodes arranged in this manner can also communicate with one or more UEs, such as described elsewhere herein. In some embodiments, some signaling can be performed via control system 18230, which can alternatively be used for communication between hardware nodes 1830 and radio units 18200.

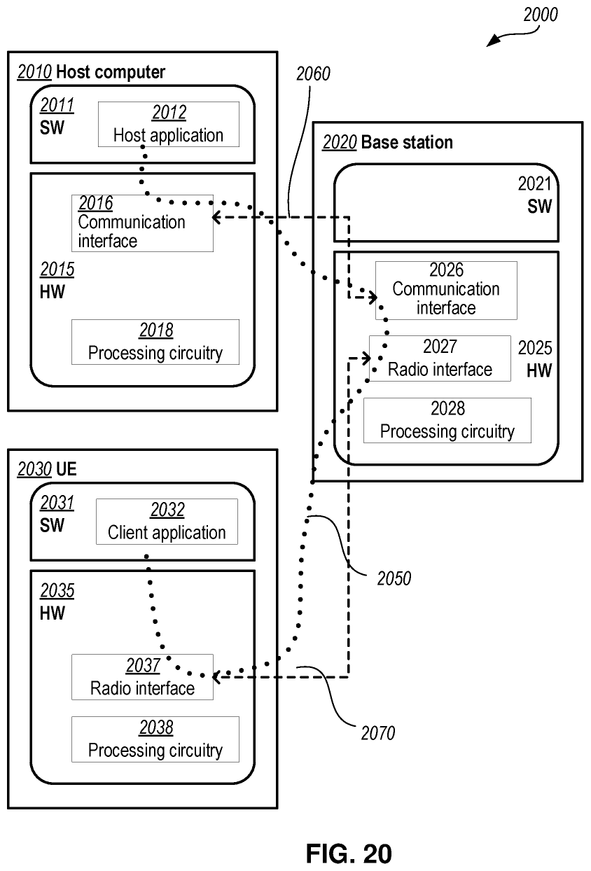

With reference to FIG. 19, in accordance with an embodiment, a communication system includes telecommunication network 1910, such as a 3GPP-type cellular network, which comprises access network 1911, such as a radio access network, and core network 1914. Access network 1911 comprises a plurality of base stations 1912a, 1912b, 1912c, such as NBs, eNBs, gNBs or other types of wireless access points, each defining a corresponding coverage area 1913a, 1913b, 1913c. Each base station 1912a, 1912b, 1912c is connectable to core network 1914 over a wired or wireless connection 1915. A first UE 1991 located in coverage area 1913c can be configured to wirelessly connect to, or be paged by, the corresponding base station 1912c. A second UE 1992 in coverage area 1913a is wirelessly connectable to the corresponding base station 1912a. While a plurality of UEs 1991, 1992 are illustrated in this example, the disclosed embodiments are equally applicable to a situation where a sole UE is in the coverage area or where a sole UE is connecting to the

Telecommunication network 1910 is itself connected to host computer 1930, which can be embodied in the hardware and/or software of a standalone server, a cloud-implemented server, a distributed server or as processing resources in a server farm. Host computer 1930 can be under the ownership or control of a service provider or can be operated by the service provider or on behalf of the service provider. Connections 1921 and 1922 between telecommunication network 1910 and host computer 1930 can extend directly from core network 1914 to host computer 1930 or can go via an optional intermediate network 1920. Intermediate network 1920 can be one of, or a combination of more than one of, a public, private or hosted network; intermediate network 1920, if any, can be a backbone network or the Internet; in particular, intermediate network 1920 can comprise two or more sub-networks (not shown).

The communication system of FIG. 19 as a whole enables connectivity between the connected UEs 1991, 1992 and host computer 1930. The connectivity can be described as an over-the-top (OTT) connection 1950. Host computer 1930 and the connected UEs 1991, 1992 are configured to communicate data and/or signaling via OTT connection 1950, using access network 1911, core network 1914, any intermediate network 1920 and possible further infrastructure (not shown) as intermediaries. OTT connection 1950 can be transparent in the sense that the participating communication devices through which OTT connection 1950 passes are unaware of routing of uplink and downlink communications. For example, base station 1912 may not or need not be informed about the past routing of an incoming downlink communication with data originating from host computer 1930 to be forwarded (e.g., handed over) to a connected UE 1991. Similarly, base station 1912 need not be aware of the future routing of an outgoing uplink communication originating from the UE 1991 towards the host computer 1930.

Example implementations, in accordance with an embodiment, of the UE, base station and host computer discussed in the preceding paragraphs will now be described with reference to FIG. 20. In communication system 2000, host computer 2010 comprises hardware 2015 including communication interface 2016 configured to set up and maintain a wired or wireless connection with an interface of a different communication device of communication system 2000. Host computer 2010 further comprises processing circuitry 2018, which can have storage and/or processing capabilities. In particular, processing circuitry 2018 can comprise one or more programmable processors, application-specific integrated circuits, field programmable gate arrays or combinations of these (not shown) adapted to execute instructions. Host computer 2010 further comprises software 2011, which is stored in or accessible by host computer 2010 and executable by processing circuitry 2018. Software 2011 includes host application 2012. Host application 2012 can be operable to provide a service to a remote user, such as UE 2030 connecting via OTT connection 2050 terminating at UE 2030 and host computer 2010. In providing the service to the remote user, host application 2012 can provide user data which is transmitted using OTT connection 2050.

Communication system 2000 can also include base station 2020 provided in a telecommunication system and comprising hardware 2025 enabling it to communicate with host computer 2010 and with UE 2030. Hardware 2025 can include communication interface 2026 for setting up and maintaining a wired or wireless connection with an interface of a different communication device of communication system 2000, as well as radio interface 2027 for setting up and maintaining at least wireless connection 2070 with UE 2030 located in a coverage area (not shown in FIG. 20) served by base station 2020. Communication interface 2026 can be configured to facilitate connection 2060 to host computer 2010. Connection 2060 can be direct, or it can pass through a core network (not shown in FIG. 20) of the telecommunication system and/or through one or more intermediate networks outside the telecommunication system. In the embodiment shown, hardware 2025 of base station 2020 can also include processing circuitry 2028, which can comprise one or more programmable processors, application-specific integrated circuits, field programmable gate arrays or combinations of these (not shown) adapted to execute instructions.

Base station 2020 also includes software 2021 stored internally or accessible via an external connection. For example, software 2021 can include program instructions (also referred to as a computer program product) that, when executed by processing circuitry 2028, can configure base station 2020 to perform operations corresponding to various exemplary methods (e.g., procedures) described herein.

Communication system 2000 can also include UE 2030 already referred to, whose hardware 2035 can include radio interface 2037 configured to set up and maintain wireless connection 2070 with a base station serving a coverage area in which UE 2030 is currently located. Hardware 2035 of UE 2030 can also include processing circuitry 2038, which can comprise one or more programmable processors, application-specific integrated circuits, field programmable gate arrays or combinations of these (not shown) adapted to execute instructions.

UE 2030 also includes software 2031, which is stored in or accessible by UE 2030 and executable by processing circuitry 2038. Software 2031 includes client application 2032. Client application 2032 can be operable to provide a service to a human or non-human user via UE 2030, with the support of host computer 2010. In host computer 2010, an executing host application 2012 can communicate with the executing client application 2032 via OTT connection 2050 terminating at UE 2030 and host computer 2010. In providing the service to the user, client application 2032 can receive request data from host application 2012 and provide user data in response to the request data. OTT connection 2050 can transfer both the request data and the user data. Client application 2032 can interact with the user to generate the user data that it provides. Software 2031 can also include program instructions (also referred to as a computer program product) that, when executed by processing circuitry 2038, can configure UE 2030 to perform operations corresponding to various exemplary methods (e.g., procedures) described herein.

It is noted that host computer 2010, base station 2020 and UE 2030 illustrated in FIG. can be similar or identical to host computer 1930, one of base stations 1912a, 1912b, 1912c and one of UEs 1991, 1992 of FIG. 196, respectively. This is to say, the inner workings of these entities can be as shown in FIG. 20 and independently, the surrounding network topology can be that of FIG. 19.

In FIG. 20, OTT connection 2050 has been drawn abstractly to illustrate the communication between host computer 2010 and UE 2030 via base station 2020, without explicit reference to any intermediary devices and the precise routing of messages via these devices. Network infrastructure can determine the routing, which it can be configured to hide from UE 2030 or from the service provider operating host computer 2010, or both. While OTT connection 2050 is active, the network infrastructure can further take decisions by which it dynamically changes the routing (e.g., on the basis of load balancing consideration or reconfiguration of the network).

Wireless connection 2070 between UE 2030 and base station 2020 is in accordance with the teachings of the embodiments described throughout this disclosure. One or more of the various embodiments improve the performance of OTT services provided to UE 2030 using OTT connection 2050, in which wireless connection 2070 forms the last segment. More precisely, the embodiments disclosed herein can improve flexibility for the network to monitor end-to-end quality-of-service (QoS) of data flows, including their corresponding radio bearers, associated with data sessions between a user equipment (UE) and another entity, such as an OTT data application or service external to the 5G network. These and other advantages can facilitate more timely design, implementation, and deployment of 5G/NR solutions. Furthermore, such embodiments can facilitate flexible and timely control of data session QoS, which can lead to improvements in capacity, throughput, latency, etc. that are envisioned by 5G/NR and important for the growth of OTT services.

A measurement procedure can be provided for the purpose of monitoring data rate, latency and other network operational aspects on which the one or more embodiments improve. There can further be an optional network functionality for reconfiguring OTT connection 2050 between host computer 2010 and UE 2030, in response to variations in the measurement results. The measurement procedure and/or the network functionality for reconfiguring OTT connection 2050 can be implemented in software 2011 and hardware 2015 of host computer 2010 or in software 2031 and hardware 2035 of UE 2030, or both. In embodiments, sensors (not shown) can be deployed in or in association with communication devices through which OTT connection 2050 passes; the sensors can participate in the measurement procedure by supplying values of the monitored quantities exemplified above, or supplying values of other physical quantities from which software 2011, 2031 can compute or estimate the monitored quantities. The reconfiguring of OTT connection 2050 can include message format, retransmission settings, preferred routing etc.; the reconfiguring need not affect base station 2020, and it can be unknown or imperceptible to base station 2020. Such procedures and functionalities can be known and practiced in the art. In certain embodiments, measurements can involve proprietary UE signaling facilitating host computer 2010's measurements of throughput, propagation times, latency and the like. The measurements can be implemented in that software 2011 and 2031 causes messages to be transmitted, in particular empty or ‘dummy’ messages, using OTT connection 2050 while it monitors propagation times, errors, etc.

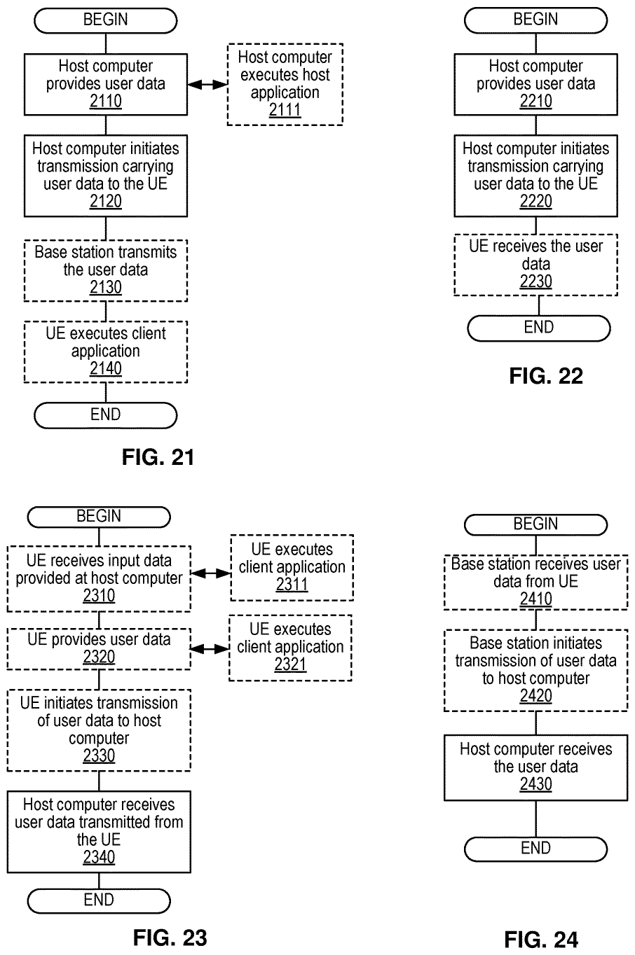

FIG. 21 is a flowchart illustrating an exemplary method and/or procedure implemented in a communication system, in accordance with one embodiment. The communication system includes a host computer, a base station and a UE which, in some embodiments, can be those described with reference to other figures herein. For simplicity of the present disclosure, only drawing references to FIG. 21 will be included in this section. In step 2110, the host computer provides user data. In substep 2111 (which can be optional) of step 2110, the host computer provides the user data by executing a host application. In step 2120, the host computer initiates a transmission carrying the user data to the UE. In step 2130 (which can be optional), the base station transmits to the UE the user data which was carried in the transmission that the host computer initiated, in accordance with the teachings of the embodiments described throughout this disclosure. In step 2140 (which can also be optional), the UE executes a client application associated with the host application executed by the host computer.

FIG. 22 is a flowchart illustrating an exemplary method and/or procedure implemented in a communication system, in accordance with one embodiment. The communication system includes a host computer, a base station and a UE which can be those described with reference to other figures herein. For simplicity of the present disclosure, only drawing references to FIG. 22 will be included in this section. In step 2210 of the method, the host computer provides user data. In an optional substep (not shown) the host computer provides the user data by executing a host application. In step 2220, the host computer initiates a transmission carrying the user data to the UE. The transmission can pass via the base station, in accordance with the teachings of the embodiments described throughout this disclosure. In step 2230 (which can be optional), the UE receives the user data carried in the transmission.

FIG. 23 is a flowchart illustrating an exemplary method and/or procedure implemented in a communication system, in accordance with one embodiment. The communication system includes a host computer, a base station and a UE which can be those described with reference to other figures herein. For simplicity of the present disclosure, only drawing references to FIG. 23 will be included in this section. In step 2310 (which can be optional), the UE receives input data provided by the host computer. Additionally or alternatively, in step 2320, the UE provides user data. In substep 2321 (which can be optional) of step 2320, the UE provides the user data by executing a client application. In substep 2311 (which can be optional) of step 2310, the UE executes a client application which provides the user data in reaction to the received input data provided by the host computer. In providing the user data, the executed client application can further consider user input received from the user. Regardless of how the user data was provided, the UE initiates, in substep 2330 (which can be optional), transmission of the user data to the host computer. In step 2340 of the method, the host computer receives the user data transmitted from the UE, in accordance with the teachings of the embodiments described throughout this disclosure.

FIG. 24 is a flowchart illustrating an exemplary method and/or procedure implemented in a communication system, in accordance with one embodiment. The communication system includes a host computer, a base station and a UE which can be those described with reference to other figures herein. For simplicity of the present disclosure, only drawing references to FIG. 24 will be included in this section. In step 2410 (which can be optional), in accordance with the teachings of the embodiments described throughout this disclosure, the base station receives user data from the UE. In step 2420 (which can be optional), the base station initiates transmission of the received user data to the host computer. In step 2430 (which can be optional), the host computer receives the user data carried in the transmission initiated by the base station.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Furthermore, functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In addition, certain terms used in the present disclosure, including the specification, drawings and embodiments thereof, can be used synonymously in certain instances, including, but not limited to, e.g., data and information. It should be understood that, while these words and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

The techniques and apparatus described herein include, but are not limited to, the following enumerated examples:
A1. A method, for a user equipment (UE), to report radio link failure (RLF) in a wireless network, the method comprising:
   after an RLF and failed connection reestablishment in a first cell associated with a first public land mobile network (PLMN), connecting to a second cell associated with a second PLMN; and
   sending, to a radio network node (RNN) serving the second cell, an RLF report including:
      a list of PLMN identifiers, including an identifier of the first PLMN; and
      an indication of whether the second cell is the cell in which the UE first reconnected.
A2. The method of embodiment A1, wherein the indication comprises:
   an identifier of the second cell, when the second cell is the cell in which the UE first reconnected; and
   no identifier of the cell in which the UE first reconnected, when the second cell is not the cell in which the UE first reconnected.
A3. The method embodiment A1, wherein the indication comprises:
   an identifier of the cell in which the UE first reconnected; and
   when the second PLMN is not identified in the list of PLMN identifiers, an indication that the UE first reconnected in a different PLMN than the second PLMN.
A4. The method of embodiment A1, wherein the indication comprises:
   when the second PLMN is identified in the list of PLMN identifiers, an identifier of the cell in which the UE first reconnected and a first indication of a time until the UE first reconnected; and
   when the second PLMN is not identified in the list of PLMN identifiers, an indication that the UE first reconnected in a different PLMN than the second PLMN.
A5. The method of embodiment A1, wherein the indication comprises:
   a first indication of a time until the UE first reconnected; and
   when the second PLMN is not identified in the list of PLMN identifiers, an indication that the UE first reconnected in a different PLMN than the second PLMN.
B1. A method, for a radio network node (RNN) in a wireless network, to receive radio link failure (RLF) reports from user equipment (UEs), the method comprising:
   establishing a connection with a UE in a second cell, served by the RNN, that is associated with a second public land mobile network (PLMN); and
   receiving, from the UE, an RLF report including:
      a list of PLMN identifiers, including an identifier of a first PLMN in which the UE experienced RLF and failed connection reestablishment; and
      an indication of whether the second cell is the cell in which the UE first reconnected.
B2. The method of embodiment B1, wherein the indication comprises:
   an identifier of the second cell, when the second cell is the cell in which the UE first reconnected; and
   no identifier of the cell in which the UE first reconnected, when the second cell is not the cell in which the UE first reconnected.
B3. The method embodiment B1, wherein the indication comprises:
   an identifier of the cell in which the UE first reconnected; and
   when the second PLMN is not identified in the list of PLMN identifiers, an indication that the UE first reconnected in a different PLMN than the second PLMN.
B4. The method of embodiment B1, wherein the indication comprises:
   when the second PLMN is identified in the list of PLMN identifiers, an identifier of the cell in which the UE first reconnected and a first indication of a time until the UE first reconnected; and
   when the second PLMN is not identified in the list of PLMN identifiers, an indication that the UE first reconnected in a different PLMN than the second PLMN.
B5. The method of embodiment B1, wherein the indication comprises:
   a first indication of a time until the UE first reconnected; and
   when the second PLMN is not identified in the list of PLMN identifiers, an indication that the UE first reconnected in a different PLMN than the second PLMN.
B6. The method of any of embodiments B1-B5, further comprising based on the indication, determining whether to perform mobility parameter tuning for the cell in which the UE first reconnected.
C1. A user equipment (UE) configured to report radio link failure (RLF) in a wireless network, the UE comprising:
   radio transceiver circuitry configured to communicate with a radio network node (RNN) in the wireless network; and
   processing circuitry operatively coupled to the radio transceiver circuitry, whereby the processing circuitry and the radio transceiver circuitry are configured to perform operations corresponding to the methods of any of embodiments A1-A5.
C2. A user equipment (UE) configured to report radio link failure (RLF) in a wireless network, the UE being further arranged to perform operations corresponding to the methods of any of embodiments A1-A5.
C3. A non-transitory, computer-readable medium storing computer-executable instructions that, when executed by processing circuitry of a user equipment (UE) configured to report radio link failure (RLF) in a wireless network, configure the UE to perform operations corresponding to the methods of any of embodiments A1-A5.
C4. A computer program product comprising computer-executable instructions that, when executed by processing circuitry of a user equipment (UE) configured to report radio link failure (RLF) in a wireless network, configure the UE to perform operations corresponding to the methods of any of embodiments A1-A5.
D1. A radio network node (RNN) arranged to receive radio link failure (RLF) reports from user equipment (UEs) in a wireless network, the RNN comprising:
   communication interface circuitry configured to communicate with one or more UEs and with one or more further RNNs in the wireless network; and
   processing circuitry operatively coupled to the communication interface circuitry, whereby the processing circuitry and the communication interface circuitry are configured to perform operations corresponding to the methods of any of embodiments B1-B6.
D2. A radio network node (RNN) arranged to receive radio link failure (RLF) reports from user equipment (UEs) in a wireless network, the RNN being further arranged to perform operations corresponding to the methods of any of embodiments B1-B6.
D3. A non-transitory, computer-readable medium storing computer-executable instructions that, when executed by processing circuitry of a radio network node (RNN) arranged to receive radio link failure (RLF) reports from user equipment (UEs) in a wireless network, configure the RNN to perform operations corresponding to the methods of any of embodiments B1-B6.
D4. A computer program product comprising computer-executable instructions that, when executed by processing circuitry of a radio network node (RNN) receive radio link failure (RLF) reports from user equipment (UEs) in a wireless network, configure the RNN to perform operations corresponding to the methods of any of embodiments B1-B6.

1.-34. (canceled)

35. A method for a user equipment (UE) to report link failures in a wireless network, the method comprising:
after a link failure and a failed connection reestablishment in a first public land mobile network (PLMN) connecting to a first cell in the wireless network; and
sending, to a radio network node (RNN) in the wireless network, a failure report including an indication of whether the first cell is associated with the first PLMN.

36. The method of claim 35, further comprising, in response to the link failure, storing a list of PLMN identifiers associated with a cell in which the link failure occurred, including an identifier of the first PLMN.

37. The method of claim 36, wherein:
connecting to the first cell in the wireless network comprises receiving an RRCSetup message via the first cell; and
the method further comprises determining whether the first cell is associated with any of the PLMN identifiers included in the list.

38. The method of claim 37, wherein the indication comprises:
an identifier of the first cell, when the first cell is associated with at least one PLMN identifier included in the list and the RRCSetup message is an initial RRCSetup message received by the UE after the link failure and the failed connection reestablishment; and
no identifier of the first cell, when the first cell is not associated with any of the PLMN identifiers included in the list or the RRCSetup message is not an initial RRCSetup message received by the UE after the link failure and the failed connection reestablishment.

39. The method of claim 37, wherein the failure report further comprises:
a further indication of time elapsed since the link failure, when the first cell is associated with at least one PLMN identifier included in the list and the RRCSetup message is an initial RRCSetup message received by the UE after the link failure and the failed connection reestablishment; and
no further indication of time elapsed since the link failure, when the first cell is not associated with any of the PLMN identifiers included in the list or the RRCSetup message is not an initial RRCSetup message received by the UE after the link failure and the failed connection reestablishment.

40. The method of claim 36, wherein the RNN is part of at least one of the PLMNs identified in the list.

41. The method of claim 36, wherein one or more of the following applies:
the link failure is a radio link failure (RLF) or a handover failure (HOF) declared by the UE in the first PLMN;
the list of PLMN identifiers is included in the failure report; and
the failure report is an RLF report.

42. A method for a radio network node (RNN) in a wireless network to receive failure reports from user equipment (UEs), the method comprising:
receiving, from a UE, a failure report including an indication of whether a first cell, to which the UE connected after a link failure and after a failed connection reestablishment in a first public land mobile network (PLMN) is associated with the first PLMN.

43. The method of claim 42, wherein the failure report includes a list of PLMN identifiers associated with a cell in which the link failure occurred, including an identifier of the first PLMN.

44. The method of claim 43, further comprising, before receiving the failure report, sending the UE an RRCSetup message via the first cell.

45. The method of claim 44, wherein the indication comprises:
an identifier of the first cell, when the first cell is associated with at least one PLMN identifier included in the list and the RRCSetup message is an initial RRCSetup message received by the UE after the link failure and the failed connection reestablishment; and
no identifier of the first cell, when the first cell is not associated with any of the PLMN identifiers included in the list or the RRCSetup message is not an initial RRCSetup message received by the UE after the link failure and the failed connection reestablishment.

46. The method of claim 44, wherein the failure report further comprises:
a further indication of time elapsed since the link failure, when the first cell is associated with at least one PLMN identifier included in the list and the RRCSetup message is an initial RRCSetup message received by the UE after the link failure and the failed connection reestablishment; and
no further indication of time elapsed since the link failure, when the first cell is not associated with any of the PLMN identifiers included in the list or the RRCSetup message is not an initial RRCSetup message received by the UE after the link failure and the failed connection reestablishment.

47. The method of claim 43, wherein the RNN is part of at least one of the PLMNs identified in the list.

48. The method of claim 42, wherein one or more of the following applies:
the link failure is a radio link failure (RLF) or a handover failure (HOF) declared by the UE in the first PLMN; and
the failure report is an RLF report.

49. The method of claim 42, further comprising selectively performing mobility parameter tuning for the first cell based on the indication, including refraining from performing mobility parameter tuning for the first cell when the indication indicates that the first cell is not associated with the first PLMN in which the UE's failed connection reestablishment occurred.

50. A user equipment (UE) configured to report link failures in a wireless network, the UE comprising:
communication interface circuitry configured to communicate with a radio network node (RNN) in the wireless network; and
processing circuitry operatively coupled to the communication interface circuitry, whereby the processing circuitry and the communication interface circuitry are configured to:
after a link failure and a failed connection reestablishment in a first public land mobile network (PLMN) connect to a first cell in the wireless network; and
send, to the RNN, a failure report including an indication of whether the first cell is associated with the first PLMN.

51. The UE of claim 50, wherein the processing circuitry is further configured to, in response to the link failure, store a list of PLMN identifiers associated with a cell in which the link failure occurred, including an identifier of the first PLMN.

52. The UE of claim 51, wherein:
the processing circuitry and the communication interface circuitry are configured to connect to the first cell in the wireless network based on receiving an RRCSetup message via the first cell; and
the processing circuitry and the communication interface circuitry are further configured to determine whether the first cell is associated with any of the PLMN identifiers included in the list.

53. The UE of claim 52, wherein the indication comprises:
an identifier of the first cell, when the first cell is associated with at least one PLMN identifier included in the list and the RRCSetup message is an initial RRCSetup message received by the UE after the link failure and the failed connection reestablishment; and
no identifier of the first cell, when the first cell is not associated with any of the PLMN identifiers included in the list or the RRCSetup message is not an initial RRCSetup message received by the UE after the link failure and the failed connection reestablishment.

54. The UE of claim 52, wherein the failure report further comprises:
a further indication of time elapsed since the link failure, when the first cell is associated with at least one PLMN identifier included in the list and the RRCSetup message is an initial RRCSetup message received by the UE after the link failure and the failed connection reestablishment; and
no further indication of time elapsed since the link failure, when the first cell is not associated with any of the PLMN identifiers included in the list or the RRCSetup message is not an initial RRCSetup message received by the UE after the link failure and the failed connection reestablishment.

55. A radio network node (RNN) configured to receive failure reports from user equipment (UEs) in a wireless network, the RNN comprising:
communication interface circuitry configured to communicate with one or more UEs and with one or more further RNNs in the wireless network; and
processing circuitry operatively coupled to the communication interface circuitry, whereby the processing circuitry and the communication interface circuitry are configured to perform operations corresponding to the method of claim 42.
